(19) United States
(12) Patent Application Publication
(10) Pub. No.: US 2013/0325572 A1
(43) Pub. Date: Dec. 5, 2013

(54) VIRAL REWARDING IN A PEER COMPENSATED ADVERTISING SYSTEM

(71) Applicant: William J. PLUT, Los Altos, CA (US)

(72) Inventor: William J. PLUT, Los Altos, CA (US)

(73) Assignee: TRUSTEDAD, INC., Menlo Park, CA (US)

(21) Appl. No.: 13/482,757

(22) Filed: May 29, 2012

(51) Int. Cl. G06Q 30/02

(52) U.S. Cl. 705/14.16; 705/14.69

(57) ABSTRACT

An interpersonal electronic advertising system is described. The system is configured to enable an ad suggester to select and send ads for a product or service to an ad recipient. The suggested ad can lead to a purchase of the product or the service by the ad recipient and in response the system can compensate the ad suggester. The system can be configured to reward users that invite and successfully recruit other individuals to join the system. Rewards for a particular user can be based upon the activities of their recruits, such as successful purchases resulting from ads that they have suggested. In a particular embodiment, the rewards for a particular user can be based upon a total value of purchases that have been generated from their recruits. Different reward amounts can be sequentially provided each time the total value of purchases exceeds respective threshold amounts.

### FIELD OF THE INVENTION

This invention generally relates to electronic advertising and digital social sales, and more particularly to systems and methods for acquiring new users in an interpersonal electronic advertising system.

### BACKGROUND

Advertising plays a central role in marketing numerous products and services. Prior online advertisement providers use automated tools to send an advertisement to a person based on demographic characteristics and past contextual knowledge of the person, such as the online traffic content, or using information gathered from Internet searches, email content, or location detection technology.

For a number of reasons, these automated forms of advertisement based on prior online data suffer from a relatively low ratio of conversion into actual purchases. First, online users are inundated with irrelevant advertisements that collectively desensitize a viewer because the advertisements are based on outdated data and no longer relevant to their changing needs. Advertisements frequently show a product that has already been purchased. A person's needs change. For example, if an Internet user builds a car online at a car manufacturer's site, then the person will continue to receive ads for that car, irrespective if they actually liked the car, or whether they found a better car. More importantly, some advertisement providers selfishly display ads according to their highest paying advertiser. This is clearly not in the best interest of a particular ad recipient.

Based on the foregoing, there is a need for systems and methods for improved electronic advertising.

### BRIEF DESCRIPTION OF THE DRAWINGS

FIG. 1 illustrates a system for sending an interpersonal electronic advertisement in accordance with the described embodiments.

FIG. 2 illustrates a flow chart of a method for sending a suggested electronic advertisement and attributing compensation in accordance with the described embodiments.

FIG. 3 illustrates a graphical user interface for displaying a viewable page including one or more suggested ad in accordance with the described embodiments.

FIG. 4 illustrates a graphical user interface configured to allow a user to monitor their activities in an interpersonal electronic advertising system in accordance with the described embodiments.

FIGS. 5A, 5B and 5C illustrate a graphical user interface configured to allow a user to monitor their progress towards rewards resulting from the activities within the interpersonal electronic advertising system of other users that have been referred to the system by the user in accordance with the described embodiments.

FIG. 6 illustrates a graphical user interface that allows a user to invite a non-user to join the interpersonal advertising system in accordance with the described embodiments.

FIG. 7 is a flow chart of a method of user registration and compensation in an interpersonal electronic advertising system in accordance with the preferred embodiments.

FIG. 8 is a flow chart of a method of user registration including referral rewards in accordance with the preferred embodiments.

FIG. 9 illustrates a network in which systems and methods consistent with the principles of the invention may be implemented.

FIG. 10 illustrates a sample computer system suitable for implementing some embodiments described herein.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As described herein, embodiments of interpersonal electronic advertising methods and systems leverage information provided from an intended advertisement recipient (or ‘intended recipient’, or ‘ad recipient’, or ‘recipient’) to an electronic advertisement suggester (or ‘ad suggester’ or ‘suggester’). The interpersonal electronic advertisement system enables the ad suggester to use information received from the ad recipient to select and send electronic advertisements, or ads, to the ad recipient. The system enables the ad suggester to be compensated when the recipient activates the ad.

An activation of the ad can involve the ad recipient completing a purchase associated with the advertisement. For instance, via a user interface, the ad recipient can select an ad created by the ad suggester. The ad can advocate a particular product or service. After selecting the ad, the interface can be reconfigured to allow the ad recipient to complete a purchase. After the purchase is completed, the ad suggester can be compensated.

An ad suggester and an ad recipient can have a relationship that involves the sharing of consumer information. For instance, the ad recipient may tell the ad suggester that they wish to purchase a particular product or service in the near future. With this knowledge, the ad suggester can use the interpersonal electronic advertising system to send timely and relevant ads to the recipients, which have a high likelihood of action by the recipient since delivery comes via a current and trusted source. It is believed that in many situations the likelihood of action by the ad recipient, such as purchase resulting from a received ad, will be much higher than previous automated electronic advertising systems. With higher likelihood of action by the ad recipient, the ad suggester can be compensated at a much higher rate than current electronic advertising systems afford.

As mentioned in the previous paragraph, via their interpersonal communications an ad suggester within the system can receive consumer information from a potential ad recipient. The ad suggester can use the consumer information as a basis for selecting and sending suggested ads to an ad recipient. The interpersonal communications can involve direct, face-to-face communications or electronic methods, such as voice, instant messaging, text, email, or twitter feed, where an electronic device is employed to enable the communication. As an example, in a text or in a face to face conversation an ad recipient can tell the ad suggester that they desire to purchase a product or service in the near future. In other instances, the ad suggester can also obtain consumer information associated with the ad recipient by indirect methods. For example, the ad suggester can obtain consumer information associated with the ad recipient through observation of preferences expressed in previous purchases made by the ad recipient or through the observation of the ad recipient's interaction with other individuals besides the ad suggester. As another example, a daughter may receive an email from her mother indicating that mom wants a necklace as her anniversary present from dad; the daughter then creates an interpersonal ad for her dad based on the timely knowledge from mom. In either case, the ad suggester now has personal and intimate and timely consumer information relating to a consumer need for the ad recipient.

As described above, using consumer information, the ad suggester can use the system described herein to suggest or select an electronic advertisement for provision to the ad recipient. For example, a man tells his cousin that he is planning a trip and needs to purchase new luggage. This is sufficient information for the cousin to use the interpersonal electronic advertising system to select and send the man an advertisement featuring a particular brand and model of luggage. The cousin may select the particular brand and model based upon additional consumer information the cousin knows about the man, such as how much he typically spend on items, whether he tends to pack a lot, or what type of luggage the man prefers. The man can favorably receive the ad because 1) it arrives from a trusted source with timely knowledge, 2) it is personalized to his preferences and 3) the man is aware the cousin will be compensated if he purchases the luggage via the ad provided through the system.

In some implementations, the interpersonal electronic advertising system can include one or more servers coupled to a network. An ad suggester can access the server via one of their personal electronic devices, such as a home computer or mobile device. The server can be configured to generate an interface for an ad suggester on their device that includes electronic advertisement data. Via the interface, the server is configured to receive electronic advertisement input (or a ‘suggestion’) from the ad suggester. In response to the suggestion, the server can send an electronic advertisement to the ad recipient.

Via the interpersonal electronic systems described herein, interfaces can be provided where an ad suggester or an ad recipient can view a number of different suggested ads. The suggested ads created by the ad suggester can be sent to various ad recipients. The ads viewed by the ad recipient may have been suggested by one or more ad suggesters. In one embodiment, the interface is associated with a social network profile page of an ad suggester. The system can be configured to serve a visitor to the page suggested ads selected by the ad suggester specifically for the visitor.

The operator revenues derived from an interpersonal electronic advertising system will generally increase as a number of users utilizing the system increases. Thus, in general, it will be desirable for an operator of the system to increase their user base. A new user can be added via a registration process where the new user provides identification information and is assigned an account. After obtaining an account, the new user can begin suggesting ads to ad recipients which can be users and non-users of the system. Based on the activities of the ad recipients that have received their suggested, such as purchases, the new user can be attributed compensation. During registration the new user can include payment information, such as bank account information, that allows them to receive the attributed compensation.

To encourage non-users to join the system, suggested ads that are sent to non-users can include information that encourages the non-user to join the interpersonal electronic advertising system. For example, when a suggested ad is displayed on an electronic device, information encouraging registration with the system, such as a selectable button with the words “register now” can be provided. When the button is selected, a registration process can be initiated. For instance, in response to a selection of the registration button, a web-page with a registration interface can be output to the non-users electronic device. The non-user can use the registration interface to join the interpersonal electronic advertising system.

In another example, the interpersonal electronic advertising system can provide an interface that allows a user to invite a friend to join the system. Via the interface, a user can enter an invitees name and contact information, such an e-mail address, that allows an invite message to be sent to the invitee. The invite message can include a mechanism, such as the selectable button described in the previous paragraph, which can be used to initiate a registration process with the system.

The system can be configured to award compensation to user's that personally refer other individuals, such as their friends to register with the system. The compensation of a user that has referred other users, referrals, to the system can be based upon the activities of the referrals on the system. For instance, in one embodiment, the user can be compensated based upon the total amount purchases that have resulted from suggested ads that their referrals have sent using the system.

In particular embodiments, the system can include an interface that explains compensation that can be earned via referrals. In addition, the system can include an interface that allows the user to monitor their progress towards rewards. For instance, the system can output via the interface, a number of people that the user has referred to the system, a total value of purchases made by the referrals and a threshold amount of the total value of purchases that are needed to earn a reward. In one embodiment, a tiered reward system with multiple threshold amounts for rewards can be provided. For example, after the total value of purchases by a user's referrals exceeds a first amount a first reward can be earned. Then, after total value of purchases exceeds a second amount, a second reward can be earned.

One aspect of the described embodiments can be generally characterized as a method in an interpersonal electronic advertising system. The method can be generally characterized as including: 1) generating in a processor a first account for a first user; 2) receiving in the processor selections of first suggested ads for first ad recipients from the first user; 3) generating in a processor a second account for a second user; 4) receiving in the processor selections of second suggested ads for second ad recipients from the second user; and 5) attributing in the processor compensation to the first account and the second account based upon purchases resulting from the second suggested ads.

Another aspect of the described embodiments can also be characterized as a method in an interpersonal advertising system. The method can include 1) generating in a processor an account for a first user; 2) generating in the processor accounts for a plurality of users referred to the system by the first user; 3) receiving in the processor selections of a plurality of suggested ads from the plurality of users; 4) based upon purchases resulting from the plurality of suggested ads, determining in the processor a reward in a referral reward program for the first user; and 5) crediting in the processor the reward to the first user. This may occur when the reward satisfies one or more objectives associated with the reward.

Techniques and methods described herein can find use with a wide array of electronics devices. For example, desktop and laptop computers are now common and may implement software that permits users to select and send and receive ads. Electronic interpersonal advertising as described herein is also suitable for use with mobile electronic devices such as personal digital assistants (PDAs), cellular telephones, smartphones, portable computer systems, thin clients, portable tablet computers, audio players, among others, because of the inherent portability of such devices.

All or portions of the subject invention may be implemented as a method, apparatus, system or article of manufacture using programming and engineering techniques to produce software, firmware, hardware or any combination thereof to control an electronic device to implement the present invention. The term “article of manufacture” as used herein is intended to encompass a computer program with executable instructions accessible from any computer readable device, carrier, or media. For example, computer readable media can include but is not limited to magnetic storage devices, optical disks, smart cards, flash memory devices among others. Of course, those skilled in the art will recognize many modifications may be made to this configuration without departing from the scope or spirit of the disclosed invention.

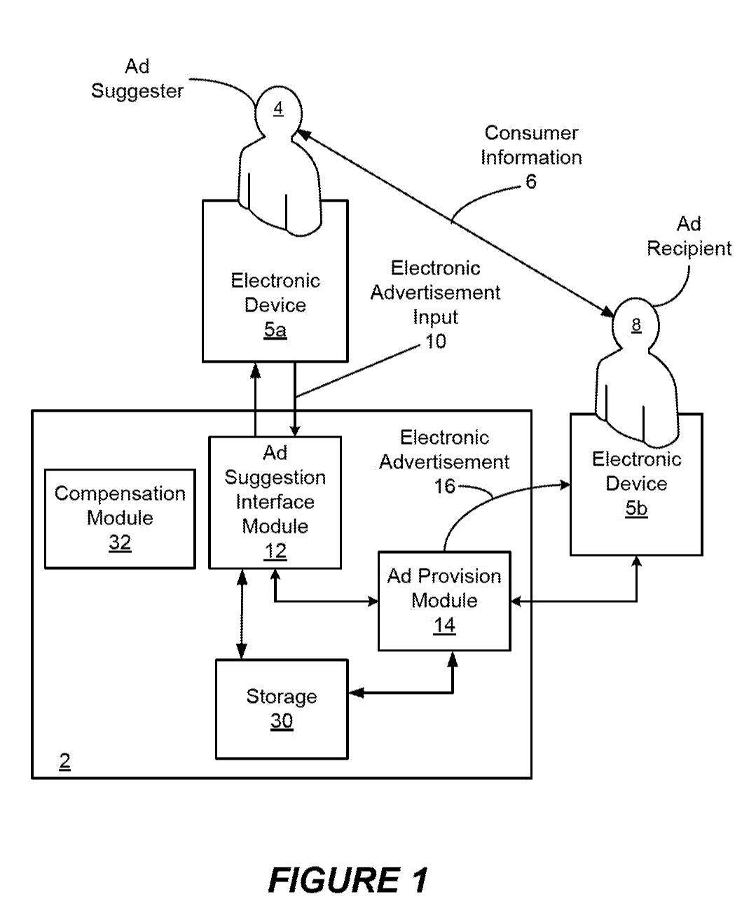

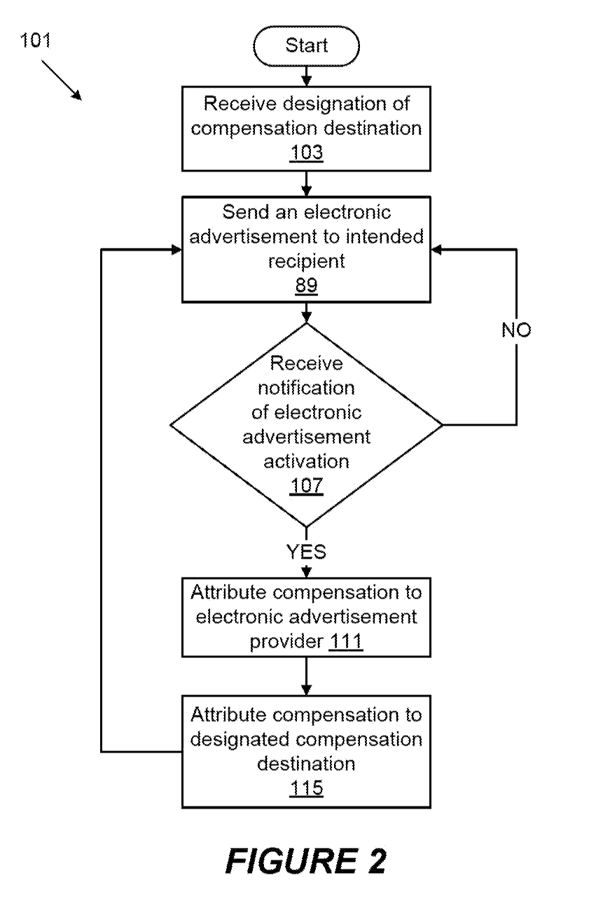

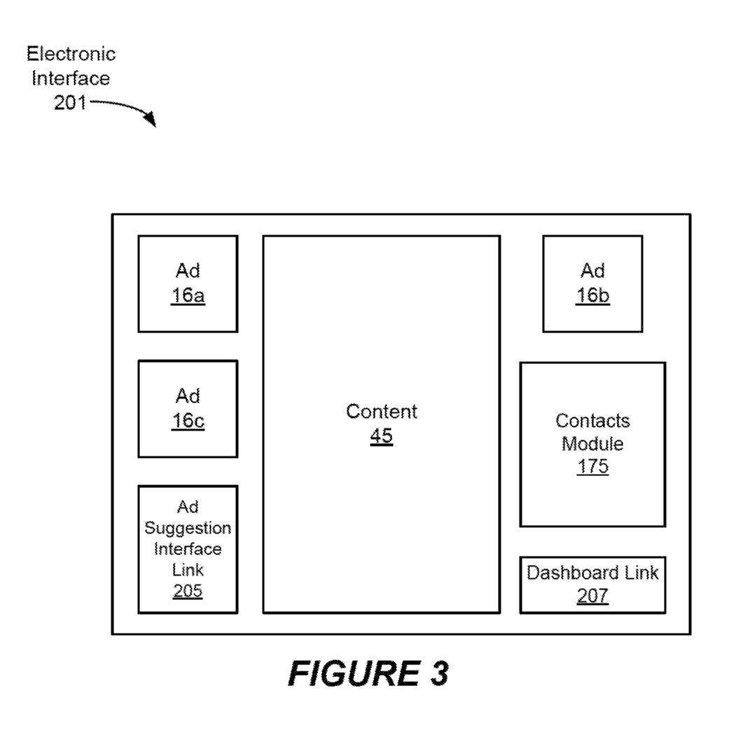

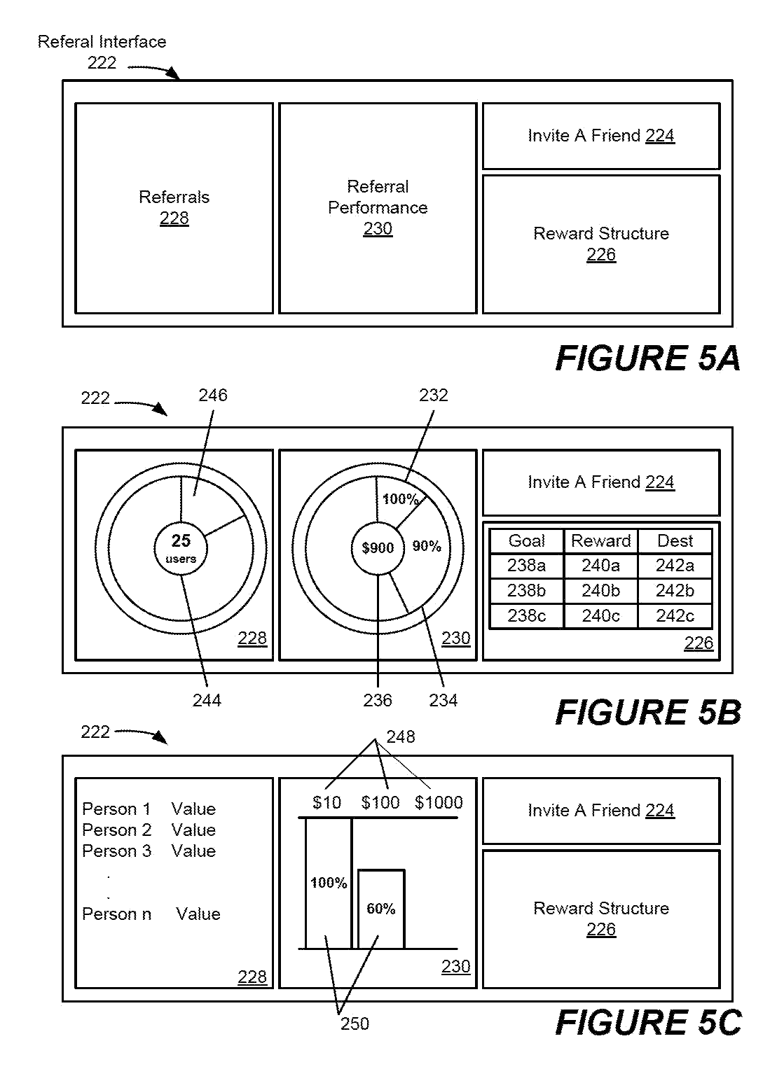

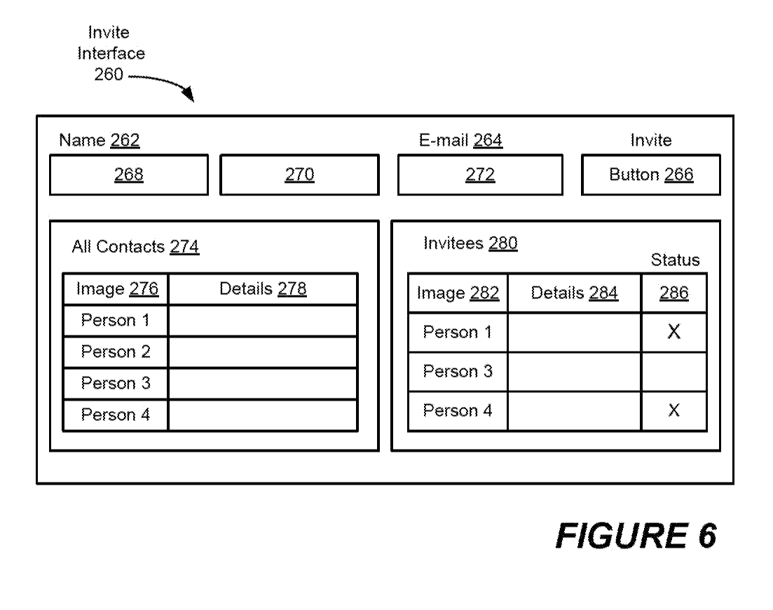

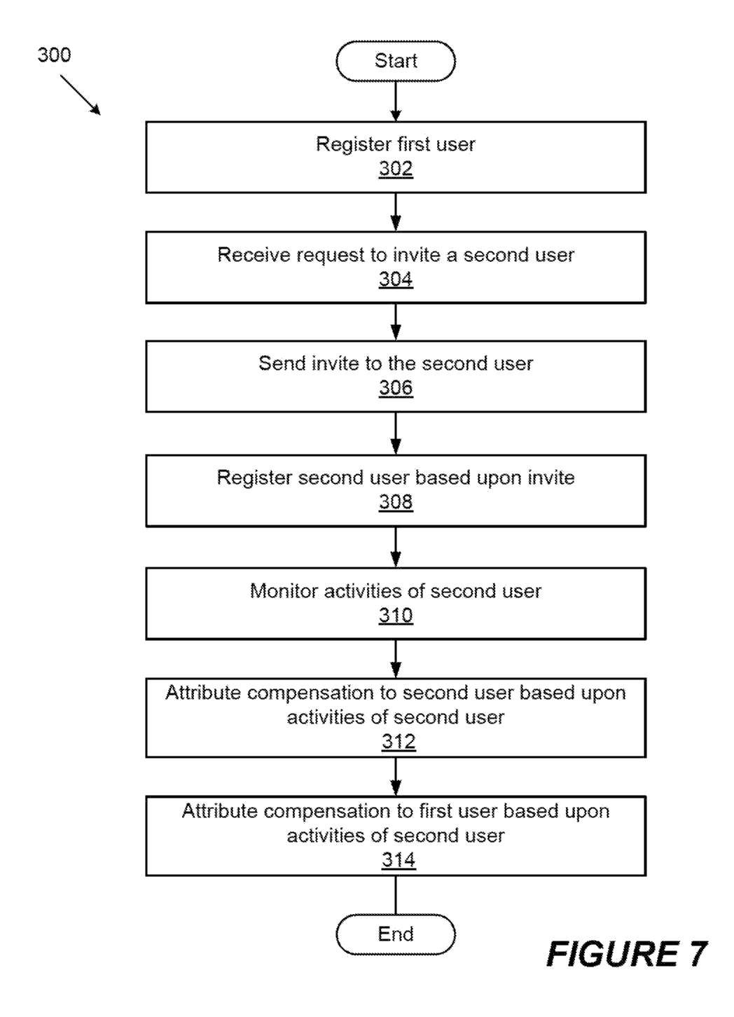

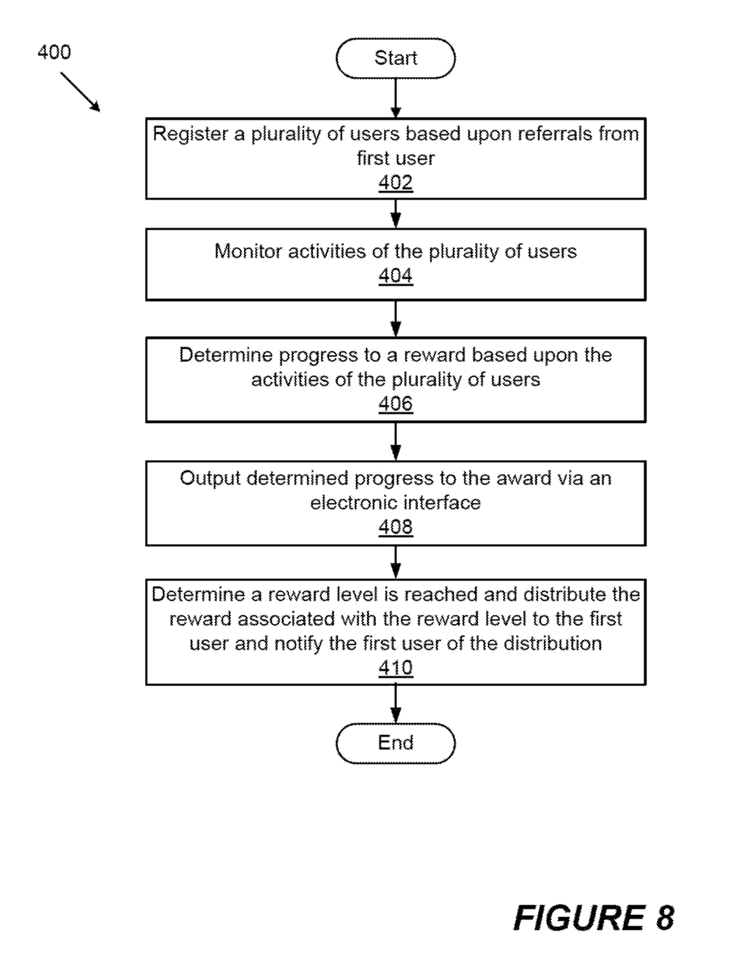

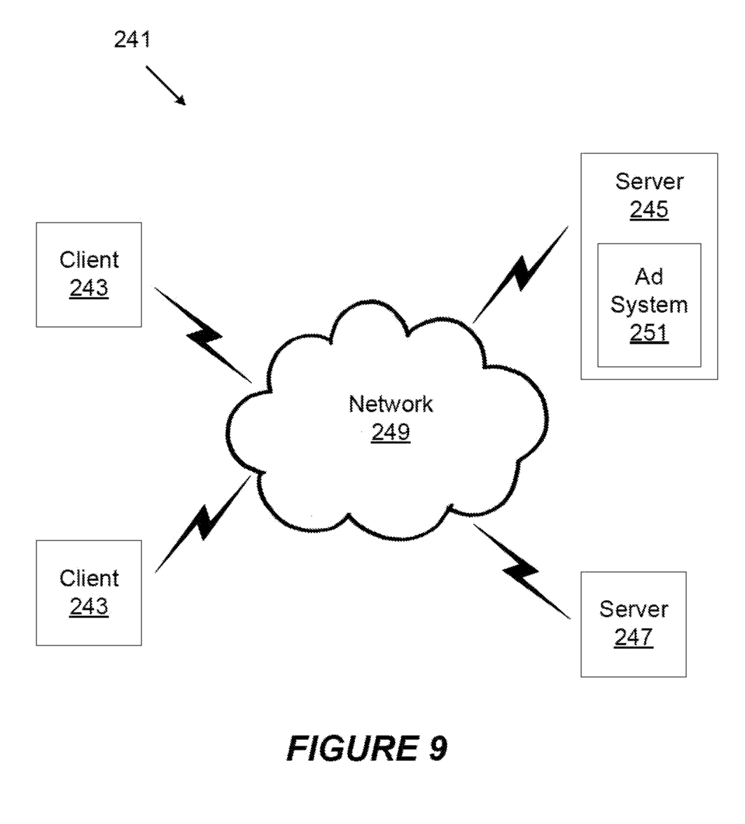

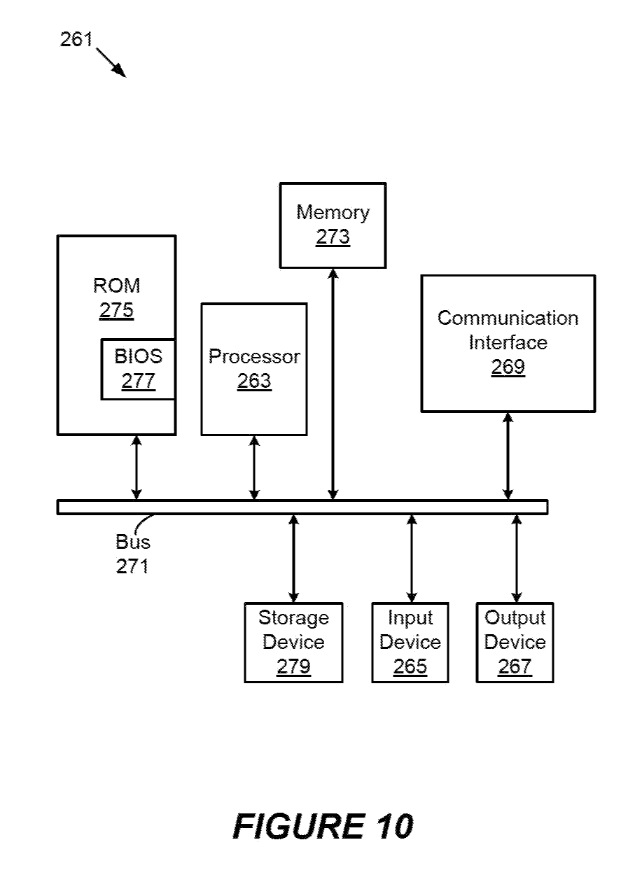

An interpersonal electronic system including compensation for new user referrals is described with respect to the following figures and sections. In particular, an overview of the interpersonal advertising system is described with respect to FIGS. 1 and 2. In particular, consumer information, creating and suggesting ads based upon the consumer information and compensation for sending suggested ads that result in a purchase by an ad recipient are described. In addition, methods for determining for an ad suggester various ad suggestion effectiveness metrics are described. With respect to FIG. 3, one example of an interface that allows an ad recipient to view suggested ads is described. One example of an interface that allows an ad suggester to monitor their activities within the interpersonal electronic advertising system is described. In particular, with respect to FIGS. 5A, 5B, 5C and 6, an interface that allow the user to monitor their activities related to user referrals within the system and refer new users are discussed. With respect to FIGS. 7 and 8, methods of registering new users to the system including compensation for existing users that have referred the new users is described. Finally, system and system components that can be utilized in an interpersonal electronic advertising system are described with respect to FIGS. 9 and 10.

### Interpersonal Electronic Advertising System

FIG. 1 illustrates a system 2 for sending electronic advertisements in accordance with one embodiment. System 2 includes an advertisement suggestion interface module 12, ad provision module 14, storage 30 and compensation module 32. The system 2 can be configured to interact with numerous electronic devices, such as 5a and 5b. In the example in FIG. 1, electronic device 5a is controlled by an ad suggester 4 and electronic device 5b is controlled by an ad recipient 8.

As described in more detail below, the ad suggestion interface module 12 can relate to system components that allow an ad suggester to suggest an advertisement. Whereas, the advertisement provision module 14, or ad provision module 14 can refer to any device, system or tool within system 2 configured to send ad 16 to intended ad recipient 8. Data storage 30 can include hardware and/or software for storing information related to system 2. Typically, when the ad suggester 4 selects and sends an ad that leads to a purchase by the ad recipient, compensation is attributed to the ad suggester 4. Compensation module 32 can be configured to attribute an incentive or compensation within interpersonal advertising system. Compensation can refer to any type of incentive, whether monetary, or in another form such as a discount on a present or future consumer transaction, coupon, merchandise, award, products, services, electronic tokens, virtual currency, rebate, among others.

During operation, the system 2 can be configured to interact with a various numbers of electronic devices where the number of electronic device interacting with the system can vary over time. The system 2 can provide different functions to each of the electronic devices and the functions provided to each device can change over time. For instance, at a first time, individual 8 can engage with system 2 as an ad recipient via device 5b. At a later time, individual 8 can engage with the system 2 as an ad suggester via device 5b. In FIG. 1, for the purposes of illustration, individual 4 is referred to as ad suggester 4 and individual 8 is referred to as an ad recipient 8. However, as noted, at different times the ad suggester 4 can engage system 2 in the role of an ad recipient and the ad recipient 8 can engage the system 2 as an ad suggester.

The system 2 can be configured to establish communication connections with electronic devices, such as 5a and 5b. Via the communication connections, information can be exchanged between the electronic devices and system 2. For example, via device 5a, ad suggester 4 can select and transmit electronic advertisement input 10 to system 2. Further, an ad recipient 8 can view an electronic advertisement 16 suggested by the ad suggester 4 which the system 2 has routed such that it can be viewed on device 5b.

In description to follow, an electronic advertisement suggester 4 (also referred to herein as ad suggester 4, or suggester 4) can refer to any person that possesses consumer information 6 regarding an intended ad recipient 8. Whereas, intended electronic advertisement recipient 8 (also referred to herein as intended recipient 8, or intended electronic advertisement recipient 8, or intended ad recipient 8, or recipient 8) can refer to an intended recipient of a suggested electronic advertisement generated on system 2, such as 16. The advertisement suggester 4 can interact with the system 2 via a client device, such as device 5a to select ads, such as 16, intended for receipt by the ad recipient 8. Thus, the selected ads are suggested ads for the intended ad recipient 8 by the ad suggester 4. Ads selected in this manner are referred to as suggested ads.

The ad recipient 8 can interact with the system 2 via client device, such as device 5b, to receive the electronic advertisements suggested by the ad suggester 4, such as 16. Suitable electronic devices that can be utilized by the ad recipient 4 or the ad suggester 8 can use to interact with system 2 include but are not limited: a portable phone and/or phone number, a mobile device, a tablet, a thin client, a laptop computer, a netbook computer, a portable music player, a television, a cable display device, a desktop computer or any other electronic device configured to send and receive electronic transmissions or communications.

Data storage 30 can include hardware and/or software for storing information related to system 2. Data storage 30 can store information relating to the suggestion or provision of electronic advertisements. In specific embodiments, data storage 30 can include information relating to one or more of: a) a listing of advertisements 16, b) an entity that is related to each advertisement, c) suggesters 4, d) intended recipients 8, e) advertisement suggestion interface module 12, f) advertisement provision module 14, g) pointers or APIs to other websites or data locations that have products or advertisements, h) electronic advertisement input 10 and combinations thereof. Data storage 30 may include a database, a table, local hard disk memory, one or more RAM devices, memory available with conventional cloud computing techniques, or any means for storing information. In a specific embodiment, data storage 30 uses a relational database such those provided by Oracle Corporation of Redwood City, Calif. In another specific embodiment, data storage 30 employs an online database service, or Database-as-a-Service, (DaaS), such as those available from Microsoft Corporation of Redmond, Wash., or Amazon.com, Inc. of Seattle, Wash.

Within the system 2, the activities of both the ad suggester 4 and the ad recipient 8 can be tracked. In some instances, users of the system can be assigned one or more digital identifiers and the tracked activities can be associated with these one or more digital identifiers. In some embodiments, the system 2 can be configured receive information, such as a login and a password, that allow a user's identity to be verified and digital identifiers associated with the user to be located. After verification, activities performed by the user can be tracked and associated with their digital identifiers. Tracking information gathered by the system 2 can be stored to storage 30.

In one embodiment, the system 2 can store device information that is associated with an individual, such as the ad suggester 4 or the ad recipient 8 to storage 30. The device information can be associated with the individual when the individual regularly controls the device to interact with the system 2. Thus, when the device information for a particular device is detected, the system 2 can be configured to determine whether the device is associated with a particular individual. When the device is determined to be associated with a particular individual, activities performed using the device, such as 5a or 5b, can be associated with the individual. For instances, ad suggester 4 can register information about device 5a with the system 5a. When the system 2 detects device 5a, such as when a communication session is initiated with the device, the system 2 can determine device 5a is associated with ad suggester 4. Then, the system can be configured to attribute subsequent activities involving the system 2, such as an ad selection performed via device 5a, to ad suggester 4.

In particular embodiments, portions of the system 2 can be embedded in other systems. For instance, an ad suggestion interface module 12 can be integrated into a social media platform where the module 12 communicates with a remote ad provision module 14 in system 2 to provision ads to ad recipients. In this example, system 2 might also include its own ad suggestion interface module 12 separate from the embedded ad provision module. In another example, all the components of system 2 can be embedded in another system, such as a system associated with a social media platform. Many such configurations are possible and the example in FIG. 1 is shown for the purposes of illustration only. Further, functions attributed to each module can be combined or broken out in different manners and then the abstraction shown in FIG. 1 which is provided for the purposes of illustration only.

### Consumer Information in an Interpersonal Electronic Advertising System

As described above, an ad suggester, such as 4, can receive consumer information 6 from an intended ad recipient 8. As the term is used herein, consumer information 6 can refer to information relating to but not limited to a shopping need, recipient desire, a potential purchase, a recipient preference, an upcoming event associated with the recipient or a current or future location of the recipient. Examples of consumer information 6 include but are not limited to a) a product or service, b) price information, c) location information for recipient 8 or a store offering a product or service of potential worth to recipient 8, d) personal information related to a purchase such as a time or place of purchase, e) specific or approximate or general product and/or service information, etc. In a specific example, ad suggester 4 has knowledge that a friend recently purchased a house and wants to purchase a garage door opener that fits a garage door in the house. Consumer information 6 in this instance can include the knowledge of the friends recent house acquisition, their desire to purchase a garage door opener for his garage door, and maybe specifics on the garage door or when the recipient intends to purchase the garage door opener.

Consumer information 6 can be received directly or indirectly. The direct or in-direct communications of consumer information from recipient 8 to ad suggester 4 can involve non-electronic methods, electronic mechanisms, and combinations thereof. Non-electronic methods can include but are not limited to face to face conversations, a written note or observations of past purchases made by the recipient 8. A face to face conversation between the ad suggester 4 and the ad recipient 8 can result in a direct transmission of consumer information 6. Whereas, the ad suggester 4 can observe past purchases made by the ad recipient 8 to obtain consumer information 6.

Electronic mechanisms suitable for use herein, such as for a transmission of consumer information 6, can include a voice conservation enabled by an electronic device, an electronic message such as a text message or email from intended recipient 8 to suggester 4, a twitter feed from intended recipient 8 to suggester 4, one or more portions of an online chat conversation, one or more social networking posts, among others. For each of the electronic examples, an electronic device, such as a server, typically relays the consumer information 6 between the recipient 8 and suggester 4, and transmits the consumer information 6 to suggester 4. A direction electronic communication of consumer information 6 from ad recipient 8 to ad suggester 4 might involve the ad recipient 8 expressing a desire to purchase an item in a text message. An indirect electronic communication of consumer information 4 might involve ad recipient 8 posting a consumer need to person different from the ad suggester 4 and the ad suggester 4 viewing the post to obtain the consumer information 6.

As shown in FIG. 1, the transmission of consumer information 6 can occur via a communication channel outside of system 2. For instance, electronic device 5a and electronic 5b can enable voice communications between the ad suggester 4 and ad recipient 8 where the communications take place outside of system 2. In other embodiments, the system 2 can be configured with communication functions. For instance, system 2 can provide a chat function that allows the ad suggester 4 and the ad recipient to communicate and transfer consumer information 6. Thus, in some embodiments, although not shown, the consumer information 6 can be routed through system 2.

In more detail, as noted above, the ad suggester 4 can directly or indirectly receive consumer information 6 from the ad recipient 8. Indirect methods can involve observations that occur during the interactions or visits to the places where recipient lives or works. For instance, an ad suggester, such as 4, may notice that an ad recipient, such as 8, uses a particular product, such as a particular brand of shoes or a brand of a purse. Later, the ad suggester 4 may learn via a face-to-face conversation that the intended recipient is looking for a new purse or shoes. Based upon the consumer information they have indirectly learned, i.e., the ad recipient 8 may have never told the ad suggester 6 directly about the brand of purse they prefer, and the consumer information they have directly learned, the ad suggester 4 may select an ad for the ad recipient 8 via system 2.

As another example, an ad suggester 4 can obtain consumer information 6 when the ad suggester visits the ad recipient's 8 home. The recipient 8 may not even be present. While visiting, the ad suggester 4 may notice things about certain purchases the ad recipient 8 has made in the past. The observations the ad suggester 4 has made may later server as consumer information 6 when the ad suggester 4 is selecting an ad, such as 16, for the ad recipient 8. In yet another example, the ad suggester 4 can overhear a conversation the ad recipient 8 is having with another individual (e.g., the ad suggester 4 and ad recipient 8 can live together with other individuals) and learn consumer information 6. Thus, through interactions that occur over time, an ad suggester 4 can be directly or indirectly gathering consumer information 6 from the ad recipient 8.

In other embodiments, consumer information 6 can relate to third-parties, such as individuals or groups known by the ad suggester 4 or ad recipient 8. For instance, if the ad recipient 8 is intending to purchase an item for another individual, consumer information 6 can include information about the individual that is to receive the purchase and/or information about the ad recipient 8. If the ad recipient 8 is intending to purchase an item for a group, the consumer information 6 can include information that the ad suggester 4 knows about the group and/or ad recipient 8.

In a father/son jewelry example, a son (ad suggester 4) can have knowledge that his father (ad recipient 8) has not purchased an anniversary present for the son's mother (third party, not shown). Consumer information 6 that the son possesses may include one or more of: i) information about an upcoming wedding anniversary, ii) specific jewelry product information that mother prefers, iii) the father's current location, iv) an anticipated price range, v) that father wants to do something nice for his mother, such as buy her jewelry, vi) other types of gifts the father has bought the mother on similar occasions or vii) combinations thereof. Thus, in this example, the consumer information 6 known by the ad suggester 4 (son) is related to the ad recipient 8 (father) and additionally a third-party (mother).

As described above, a relationship between suggester 4 and intended recipient 8 can improve intended recipient's 8 reception of advertisement 16. Depending on the relationship between 4 and 8, the intended recipient may activate ads, such as 16, at a higher rate as compared to ads received from other individuals or ads generated from context-based electronic advertising systems. After the ad recipient receives an ad from the ad suggester 4, activation of the ad can involve the ad recipient using system 2 to view the ad 16, select the ad 16, or purchasing a product or service based on ad 16. As is discussed more below, the purchasing of a product or service based on ad 16 can result in compensation for ad suggester 4 via compensation module 32.

In more detail, a perception of trustworthiness can exist between the two people interacting with system 2, such as 4 and 8. When the person 8 knows that certain consumer information 6 was given to suggester 4 in a trusted communication, person 8 then may expect ad 16, or welcomes the ad based on its source. An ad provided to ad recipient in this manner may be much better received than an ad, such as 16, from a non-trusted source, such as a business that the person 8 has no history of prior interaction, knows very little about the person 8 and has paid a search service the most money for an ad spot. Systems and methods described herein however enable intended recipient 8 to receive an electronic advertisement 16 from a known suggester 4. It is believed that factors, such as the trust between the ad recipient 8 and ad suggester 4 and consumer information 6 possessed by the ad suggester 4 that was ideally used in selecting an ad for the recipient 8, increase the likelihood that intended recipient 8 views and acts on the advertisement 16 when system 2 is employed.

The system 2 can be configured to receive electronic advertisement input generated on an electronic device, such as 5a. An interface, such as an interface implemented via a web-browser or a client application executing on the electronic device can be used to provide the electronic advertisement input 10 to system 2. In one embodiment, the ad suggestion interface module 12 can be configured to generate an interface on an external electronic device, such as 2, via a client application such as a web-browser. The electronic advertisement input 10 can include data related to an ad recipient 8, such as information that allows a suggested ad to be sent to the person, consumer information 6, and/or advertisement selection received by ad suggestion interface. The ad suggester 4 may use the interface to locate an ad associated with a particular product or service provider accessible on system 2. Thus, electronic advertisement input 10 can include information related to one or more of a company, a person, an entity, a vendor, a product, or a service.

The consumer information 6 can be reflected in a selection of an advertisement within the system. In addition, the system may allow a user, such as 4, to store consumer information 6 associated with particular individuals, such as anniversaries and product preferences. In one embodiment, this information can be stored in storage 30. Consumer information 6 entered as electronic advertisement input 10 can be stored and later retrieved when the ad suggester 4 subsequently interacts with the system 2.

### Ad Suggestion and Ad Provisioning in an Interpersonal Electronic Advertising System

As described above, the ad suggestion interface module 12 can support a GUI that allows suggester 4 to suggest an ad using their consumer information 6. The GUI can be configured to allow the user to view and select various ads that can be sent to the ad recipient 8. Businesses associated with these ads can have agreed to send compensation to system 2 when an ad from system 2 has resulted in a purchase. In one embodiment, the system 2 can be configured to notify a business when an ad associated with the business has been suggested by an ad suggester 4 for an ad recipient 8. The notification message can include information that identifies the ad as having been suggested using system 2. This information may allow the business to keep track of potential transactions that can result in compensation being sent to system 2.

In particular embodiments, the GUI can be configured to allow a user to select an advertising entity or vendor, such as a business or store, which is not included in an existing set of advertisers. In such instances, suggester 4 can use the interface generated by 12 to identify the new advertising entity or vendor. In addition, the GUI can be configured to allow a suggester 4 to select, in addition to the new advertising entity or vendor, a specific product or service offered by the advertising entity or vendor. The selected product or service can be used to generate a suggested ad, such as 16. Once suggester 4 provides the electronic advertisement input 10 using the advertisement suggestion interface module 12, the system 2 can be configured to send data communication to the advertising entity or vendor informing the advertising entity or vendor that an ad 16 will be created in an attempt to bring a customer to that business.

After receiving the communication, the advertising entity or vendor may decide whether to allow system 2 to provide the suggested electronic advertisement 16 to the intended recipient 8. An affirmative response from the advertising entity or vendor can result in electronic advertisement provision by the ad provision module 14 to the intended recipient 8. In addition, the affirmation may also include an agreement by the advertising entity or vendor to compensate for use of the service provided by system 2. Information regarding the affirmative response and/or compensation agreement can be stored to storage 30.

In a specific example of involving the utilization of system 2, a son 4 can possess consumer information 6 that his father 8 wants to purchase jewelry for a wedding anniversary 6. The son 4 can establish a communication with system 2 via electronic device, such as 5a, after which an interface associated with system 2 can be generated on device 5a. As described above, the ad suggestion interface module 12 can support the generated interface. The ad suggestion interface module 12 can be configured to support an interface that is suitable to the type of electronic device 5a that is being utilized. For instance, a different interface with different capabilities can be provided for a smart phone as compared to a laptop computer.

Via the generated interface, the son 4 can select and/or send one or more ads 16 for the father 8 indicative of his consumer information 6. In addition, via the interface, the son 4 may enter consumer information 6, such as the father's anniversary. The system 2 can be configured to store this information and possibly later remind the ad suggester 4 of this upcoming event.

In particular embodiments, consumer information 6 can include timely location information. For example, the son 4 may know where the father 8 is currently shopping, e.g., at a mall near their home. Based upon this consumer information 6, the son can select and/or suggests one or more ads 16 to the father 8 for local jewelry stores in that mall. For example, the suggested ad 16 can include a 10% or 15% discount at the selected store. The discounting ad 16 may reflect an ongoing sale for a store in the mall. In another specific example, the suggested ad 16 can include a discount or coupon for use at a jewelry store specifically redeemable within a limited time period corresponding to their visit to the mall to entice recipient 8 to enter the store. The father 8 then may print out an ad 16 or coupon 16 or use a portable electronics device to present an electronic version of the ad 16 or coupon 16 (such as one electronically sent to the father and displayed on his phone that the participating store will honor) to redeem during a transaction at the advertising store when the father 8 arrives at the store.

In one embodiment, the son 4 can know information related to various modes of communication that the father utilizes, such as mobile device numbers, e-mail accounts, postal addresses, etc. The system 2 can be configured to receive and store this information as well as allow a user to select a specific mode of delivery for the suggested advertisement. For instance, knowing the father is in the mall and the father is most likely to respond to a text message, the son 4 can utilize the system to send the message at least to the father's smart phone. If desired, the system 2 can be configured to allow the son to send the message via multiple communications modes, such as the text message, an audio message delivered to the father's phone or an e-mail.

Besides sending the ad 16 directly to the father, other modes of allowing the father to view the ad are contemplated. In one embodiment, the system 2 can be configured to interact with a social media application that displays the son's profile page. The system 2 can be configured to display suggested ads to the son's profile page. When the father visits the sons profile page, the suggested ad 16 can be displayed to the father. In this manner, the father may learn about the detail. Further details of social media applications are described below with respect to FIG. 3.

After the ad 16 is sent and if the father 8 acts upon the ad 16, the system 2 can be configured (see FIG. 2) to allow the son 4 to be compensated directly or indirectly from a merchant or service provider where the father 8 made a purchase. The compensation module 32 can be configured to perform this function. As an example, a jewelry store associated with ad 16 can agree to pay a percentage of the purchase generated from ad 16 to system 2, such as 10% of the purchase. After receiving the money from the jewelry store (or immediately, depending on the relationship between the store and the system 2), the son be paid some portion of the money to the son. The participating store is will to pay such advertising fees since, without the son's help and timely advertising input 10, the store might not have made this particular sale to the father 8. At the least, the ad 16 alone may be enough to draw the father 8 into their store—first and before he visits the other stores. If it is determined the father 8 was drawn to the store as a result of receiving the ad 16, in some embodiments, the ad suggester 4 can be compensated in some manner even if a purchase isn't made. Compensation of ad suggester 8 is described in further detail below.

As described above, an interface supported and/or generated by module 12 can receive electronic advertisement input 10 entered by ad suggester 4. Again, suggesting an ad can refer to the process of providing input 10 that at least partially determines ad 16 including receiving specific input that leads to the selection of a specific ad 16. Using ad suggestion interface module 12, suggester 4 can provide input 10 that may include or more of: i) information related to the results from searching for an ad related to consumer information 6, ii) information related to the selection of an ad 16 from a list, ii) information related to identification of one or more recipients 8 for ad 16, iv) information related to entering key words and selecting input 10 or the ad 16 based on results provided in response by ad suggestion interface module 12 or v) combinations thereof. Suitable interface components to enable an ad suggestion by person 4 can include but are not limited to one or more of a: drop down box, search box, a scroll down bar, tool bar buttons, menus, text boxes that accept user input, check boxes and the like. In one embodiment, the interface components can be formulated as a GUI for output to an electronic device, such as 5a or 5b. These interface components can allow suggester 4 to suggest or specifically select one or more electronic advertisements, such as 16, from a set of advertisements available on system 2. Further, the interface component components can allow an ad suggester to view their progress related to suggesting ads, such as whether suggested ads that they previously sent have resulted in a purchase and associated compensation.

The advertisement provision module 14, or ad provision module 14 can refer to any device, system or tool within system 2 configured to send ad 16 to intended recipient 8. Ad provision module 14 is communicatively connected to ad suggestion interface module 12 and can be configured to receive data representing or at least partially identifying ad 16 from ad suggestion interface module 12. Ad provision module 14 sends data that allows intended recipient 8 to view the advertisement 16 suggested by the suggester 4 in an electronic format. In general, ad provision module 14 sends any suitable data for displaying, representing, identifying, rendering or outputting an ad 16 on a device 8. In a specific embodiment, ad provision module 14 sends a jpeg image or other suitable graphics format for the ad 16 when the ad includes graphics data for display on an electronic device, such as 5b. In another embodiment, the ad provision module can send audio files that allow an audio description of the ad to be output.

In one embodiment, the electronic advertisement suggester selects a specific ad via the interface generated by ad suggestion interface module 12, and ad provision module 14 relays this ad to the recipient 8. In another embodiment, suggester 4 only suggests a general advertisement or topic related to the ad 16 that is eventually sent to the recipient 8. In this case, the suggester does not provide input that identifies a specific ad, but provides non-specific criteria that relates to a set of advertisements that fit the non-specific criteria. The advertisement input 10 in this case includes insufficient detail to identify an ad that will be sent. Instead, the non-specific input results in a set of advertisements that fit the non-specific criteria. This leaves ad provision module 14 to select a specific advertisement 16 that will be sent to the recipient. In this instance, the consumer information 10 provided by the ad suggester 4 allows the system 2 to act as an ad suggester.

It should also be appreciated that an ad selected by suggester 4 may not be the same advertisement 16 received by recipient 8. For instance if the ad has expired since it was created, the system can select a similar or related ad to send to the recipient 8. In one embodiment, if a suggested ad, such as 16, a specific deal and deal expires before the ad is converted, the system 2 can be configured to notify the ad suggester 4 that the suggested ad is no longer valid and/or notify the ad suggested of a related ad that is valid and can be selected.

An electronic advertisement 16 that is sent via system 2 can convey any commercial opportunity to recipient 8 or other message for a potential consumer transaction. Electronic advertisement 16 can include any format or data suitable for conveying the commercial opportunity to an ad recipient. The advertisement 16 can include one or more of video data, audio data, text, graphics information, or any combination thereof. Electronic formats suitable for conveying and delivering ad 16 include: an email, an instant message, a text message (SMS or MMS), in situ ad in a web browser, a weblog (blog), a social network environment, a news feed, a webpage, a status post, a twitter update, graphics for display on a display device, etc.

In one embodiment, the system 2 can be configured to allow the ad suggester 4 to personalize a suggested ad, such as 16. For instance, in father son jewelry example, the son can send a note to father saying, “I overheard mom talking about this item at the jewelry store.” This note can be displayed with the suggested ad 16 sent to the father. The note allows the father to confirm the relationship with the sender (son) and additionally provides consumer information 6 that can aid the father 8 in the purchase. The addition of the consumer information 6 may increase the likelihood that purchase associated with the ad 16 occurs.

Recipient 8 may view an ad 16 in a wide variety of digital communication environments. In one embodiment, a social network environment displays the ad 16. In another embodiment, ad 16 is displayed in an online chat, instant message, mobile application, text message, or email. Ad 16 may also be displayed in the space of the recipient's internet browser dedicated to displaying ads. This may be done for any web page visited by the ad recipient. Other display schemes are contemplated and ad 16 is not limited to any specific display arrangement for ad 16.

It is contemplated that some actions performed by intended recipient 8 may be performed while intended recipient 8 is not online. For example, intended recipient 8 can receive advertisement 16 on a mobile device and subsequently travel to an offline location, e.g. a store, maintained by an advertiser, or an affiliate of the advertiser, such as a merchant, retailer, wholesaler, among others. Printed ads from a computer also permit an alternative to recipient 8 from needing to bring his electronic device to a brick and mortar participating store. The printed ad can include identifying information that allows the ad to be identified as a suggested ad from system 2. The recipient 8 may also use a mobile device to initiate and/or complete a transaction in an online marketplace or in a brick and mortar participating store. Such mobile commerce techniques are known to those of skill in the art. In one example, the recipient's mobile device digitally contains payment information, such as a credit card number. Participating storefronts or merchants permit the recipient to use the mobile device as a method of payment, such as using near field communication technology.

### Compensation in an Interpersonal Electronic Advertising System

System 2 can be configured to track what recipient 8 does in response to receiving ad 16. The tracked information can be used to attribute compensation to suggester 4. The tracking can include but is not limited to determining whether the recipient has acknowledged receipt of the ad, whether the recipient has visited a physical or virtual location associated with the ad and whether a purchase has resulted in response to receiving the ad 16.

In embodiment, to determine whether an ad has resulted in a purchase, during a transaction for a product or service, recipient 8 may present an ad 16 where the ad 16 includes a bar code or other identifier for the ad 16 that represents advertisement redemption data that was originally supplied by the store. Further, the ad 16 can include information that links it to system 2. During a transaction where ad 16 is utilized, the recipient's device, such as 5b, and/or a device controlled by a merchant associated with an ad may then send a message to system 2 indicating that a transaction occurred. The system 2 can be configured to store this result to storage 30 as a successful ad suggestion for suggester 4. As is described more detail below, information related to successful suggestions can be used to rank ads that are displayed via system 2. The compensation module 32 can receive information regarding the successful ad suggestion and use it to attribute compensation to the ad suggester 4.

In one embodiment, the store, advertiser, affiliate, or intended recipient 8 can take action to provide information to the system 2 that verifies that a particular transaction occurred in response to electronic advertisement input 10. For example, the advertiser, affiliate or intended recipient 8 accesses a network and transmits notification of a successful consumer transaction made by recipient 8 relating to the ad 16 or digital coupon 16 suggested by suggester 4. In other embodiments, system 2 implements automated notification of a transaction by recipient 8 and a store based on ad 16. So long as system 2 receives affirmation of a consumer transaction relating to ad 16, then system 2 knows that the transaction occurred and may attribute a compensation to ad suggester 4 or another financial destination designated by suggester 4 (such as a bank account for a charity designated by suggester 4).

The compensation module 32 can be configured to attribute an incentive or compensation within interpersonal advertising system 2. Compensation can refer to any type of incentive, whether monetary, or in another form such as a discount on a present or future consumer transaction, coupon, merchandise, award, products, services, electronic tokens, virtual currency, rebate, among others.

Compensation module 32 can attribute compensation to a compensation destination designated by suggester 4. Module 32 can attribute compensation to ad suggester 4, such that compensation is accessible to the ad suggester. In another embodiment, compensation can be attributed to a destination specified by suggester 4, such as a charity for which suggester 4 is trying to raise funds. In this instance, the compensation may not be accessible to the suggester 4 once it has been attributed. However, the system 2 can be configured to maintain records accessible to the suggester 4 that indicate a number and an amount of compensation that has been attributed to entities other than the ad suggester 4.

To allow compensation, the system 2 can be configured to receive information, such as electronic payment information, that allows compensation to be transferred to an account specified by the ad suggester. For example, to enable personal compensation, an ad suggester 4 may provide a personal checking account number to system 2 via an interface generated or supported by the system 2, such as an interface supported by the ad suggestion interface module 12. The compensation enabling information can be stored to storage 30.

When it is time to attribute compensation to the ad suggester, the compensation module 32 can retrieve the previously specified payment information. For example, when payment information includes checking information, the compensation module 32 can subsequently deposit funds in the specified checking account using the retrieved payment information. In general, the payment information can be related to: a bank account, a PayPal™ account, Spare Change account, among others. Bank accounts may include personal accounts, business accounts, those for charitable organizations, etc. Digital credits and tokens are also suitable for use.

As noted above, compensation as contemplated herein is not limited to direct compensation of the ad suggester 4. For example, a grandparent may designate attributed compensation to the bank account for a grandchild. A suggester that supports a charity may designate the charity, or a specific bank account for a charity if known, as a financial destination for one or more ad revenues. Multiple people may also specify the same charity, thereby cumulatively generating significant funds for the charity only using actions by its supporters. Thus, the payment information input into system 2 can be associated with a financial destination that is not accessible to the ad suggester 4.

In particular embodiments, the system 2 can be configured to allow an ad suggester 4 to attribute compensation to a financial destination on ad by ad basis. For instance, the ad suggester 4 can designate that if a first suggested ad results in compensation the proceeds will be credited to the ad suggester and that if a second suggested ad results in compensation the proceeds will be credited to a third party, such as a charity. The system 2 can be configured to allow a user to view for each suggested ad the designated recipient of compensation that may result from ad and allow the user to change a previously specified designated recipient of a suggested ad.

Compensation module 32 can receive a notification that recipient 8 activated electronic advertisement 16. A component of system 2, such as module 32, may place or embed a tracking identifier and/or tracking program for an advertisement, such as 16. The identifier or tracking program can include a unique identifier or software used to track the status of the ad, such as an alphanumeric code, a hexadecimal string, a cookie, etc. Whenever recipient 8 activates the ad, that activation can be tracked by module 32. If a product or service is purchased, then recipient 8 pays the advertiser, vendor or seller, or an intermediary for either, and the advertiser, vendor or seller compensates electronic advertising provider 28 for that activation. In one embodiment, compensation module 32 uses cookies to track ad and purchase status or other recipient 8 activity in response to an ad 16.

FIG. 2 illustrates a method 101 for attributing an incentive or compensation within an interpersonal advertising system in accordance with a specific embodiment of the present invention. Method 101 begins by receiving a designation of a compensation destination (103) for compensation resulting from providing input for a suggested advertisement. Compensation may be attributed to any bank account or other suitable electronic compensation destination. For example, an ad suggester may provide a personal checking account number to the interpersonal ad service at 103. The payment information associated with the compensation destination can be used to subsequently send funds to the location specified by the payment information.

Next, in 89, an ad can be selected by an ad suggester and the selected ad can be sent to an ad recipient. Next, in 107, a notification that the ad recipient activated an electronic advertisement can be received. Activation of an electronic advertisement may include one or more of: 1) completing a transaction that was initiated using the suggested ad (e.g., the recipient was sent to a website to make the purchase using a link embedded in the ad 16), 2) completing a transaction that otherwise corresponds to suggested ad (e.g., the ad brought the ad recipient to a retailer's website, and the recipient purchased a product or service similar to the product or service conveyed in the electronic ad but not the particular product or service conveyed in the electronic ad), 3) acknowledging the suggested ad (e.g., opening an e-mail or text including the suggested ad), 4) visiting a physical or virtual location associated with the suggested ad or combinations thereof.

In one embodiment, the system can attempt to proactively or periodically verify whether the intended ad recipient has activated a suggested advertisement. If the recipient activated the electronic advertisement, then method proceeds to 111. If the intended recipient hasn't activated a suggested ad, after some time period, a check can be made again to determine whether a suggested ad has been activated. The system can continue make these checks until the verification returns an affirmative result or until the suggested ad is terminated.

As described above, a tracking number and/or tracking program can be embedded in a suggested ad. The tracking numbers can refers to one or more unique identifiers used to track the status of the suggested ad. When a suggested ad is in an electronic format, a tracking program can be embedded in the suggested ad. When the suggested ad is activated, the tracking program can be configured to report a unique identifier back to the interpersonal electronic advertising system.

Thus, whenever a recipient activates the ad, that activation can be tracked online and signaled to the interpersonal electronic advertising system. If a product or service is purchased and the recipient pays the advertiser, vendor, or seller, or an intermediary, the advertiser, vendor or seller can compensate the interpersonal electronic advertising system. Next, the proceeds can be divided between the ad suggester, an operator of the interpersonal electronic advertising system and possibly a third-party partner associated with the operator.

In one embodiment, electronic tokens, such as cookies, can be used to track suggested ads, a purchase status associated with ad and/or other recipient activity resulting from receiving the suggested ad. In a specific embodiment related to online use, cookies can be used in two stages of online recipient tracking: 1) at the load of the suggested ad and 2) when the suggested ad is clicked and the recipient that initiated the click is delivered to the seller or a website for the seller, such as Amazon™, to make a purchase. Thus, the use of cookies can enable compensation for an ad suggester when the recipient activates a suggested ad. This compensation can be separate from the compensation that results if a purchase is actually made.

Next, in 111, compensation can be attributed to the operator of the interpersonal electronic advertisement system 2 described above in FIG. 1. In one embodiment, only the operator of the system and the ad suggester share the proceeds resulting from a successful purchase. The proceeds can be paid by a vendor that benefited from the purchase enabled by the ad suggester and the suggested ad provided by the interpersonal electronic advertising system. In a specific embodiment, the ad suggester and the system operator split the proceeds 50/50. In another specific embodiment, the ad suggester and system operator split the proceeds 25/75. Other splits are possible and are not limited to these examples.

In other embodiments, more than two parties can split the proceeds resulting from a successful ad suggestion. For instance, a social network site can host an ad suggestion interface. The ad suggestion interface can be coupled to the interpersonal electronic advertisement system. Proceeds associated with the activation of the suggested ads generated from the hosted interface can be split among the ad suggester, the operator of the social network site and the operator of the interpersonal electronic advertising system. In another specific embodiment, the electronic ad service provider receives compensation for providing the advertisement to the intended recipient, without any further activity by the recipient. If the ad was sent to the recipient via a social network, process flow can attribute at least a portion of the compensation to the social network. If a purchase subsequently results from the ad, then additional compensation can be attributed to one or more entities that participated in the process leading to the purchase.

Next, in 115, compensation can be directed to the financial destination associated for the suggested ad. The financial destination may have been designated in 103. In one embodiment, in 115, a record of the suggester's electronic advertisement input and the suggested ad that corresponds to the input which was sent to the intended ad recipient can be stored. Further, the system can store a record indicating that the compensation has been attributed including information regarding the designated recipient of the compensation.

Compensation for a purchase may vary. In one embodiment, process flow 101 attributes compensation to an ad suggester based on a percentage of a transaction, where the percentage does not change over time. A compensation percentage that does not change between successive activated ads is referred to herein as a ‘flat rate’ compensation percentage. In the jewelry store example described above, the son may receive a flat rate compensation percentage for all of his suggested ads, such as 5%, therefore receiving 5% of the transaction price of his father's purchase at jewelry store.

In another embodiment, a variable compensation structure can be implemented. For example, an ad suggester can be paid a higher compensation percentage on their first ad that is successfully acknowledged by an ad recipient, or their first ad that successfully resulted in a purchase by the ad recipient. The higher initial compensation might be used as incentives in order to enlist new ad suggesters to utilize the system. After the first ad is acknowledged and/or results in a subsequent purchase, a second compensation percentage (e.g., a lower flat rate) can be implemented for the ad suggester.

In another specific embodiment, the ad suggester can receive a compensation percentage until a minimum number of ads are sent, so as to provide initial incentive to utilize the interpersonal advertising system. After the minimum numbers of suggested ads are sent, the incentive structure can change, e.g., it can go to a flat rate or becomes variable according to the tiered system. In this second instance, once the minimum numbers of ads are sent, the system can be configured to change the incentive in relation to the number of successful activations. In this manner, an ad suggester receives a first compensation percentage for an initial threshold number of ad suggestions, and receives a variable rate of return, as further described above, once the initial threshold is met.

In some embodiments, the dynamic rate of return does not fall below the initial flat rate. For example, a sample incentive scheme offers compensation for the first twenty suggested ad activations at 5% of the corresponding transactions. The ad suggesters first suggested ad can be a jewelry store ad to his father. The father can activate the ad by using it at jewelry store in a consumer transaction. The total purchase price can be $500, the ad suggester (son) son receives $25 since it was son's first suggested ad. The son can continue to receive this 5% rate for activations of his suggested ads until he provides twenty (or some other threshold) suggested ads that result in ad activations. Subsequently, another transaction scheme, such as a variable compensation scheme can be utilized.

Other compensation schemes are contemplated. In another embodiment, the compensation percentage varies in relation to the total amount of the transaction price. For example, the incentive rate for a $100 ski rack might be 5%. Thus, the ad suggester of the ski rack receives $5 dollars when a purchase results from the suggested. Whereas, the incentive rate for a $10,000,000 home purchase or yacht might be 1% and the ad suggester receives $100,000 dollars. In this manner, a business can control how much it rewards suggesters to bring customers to the business. In another compensation scheme, a flat fee for a purchase can be implemented that is irrespective of the purchase price or conversion rate or any other factor. For example, an ad suggester $3 can be paid for a certain ad that converts into a purchase by the recipient.

After attribution of compensation in 115, the 101 may repeat and return to 89 and new electronic advertisements can be sent to the recipient.

### Ad Suggestion Effectiveness Metrics

In the embodiments, described herein different metrics can be generated to characterize an ad suggester's effectiveness at suggesting ads to ad recipients. The ad suggester's determined effectiveness can vary from person to person. For instance, an ad suggester may be very effective at suggesting ads for their parents but not so effective at suggesting ads for their younger sibling. As another example, an ad suggester may be very effective at suggesting ads for their spouse but not so effective at suggesting ads for their adult children.

Besides from person to person, an ad suggester's effectiveness can be defined in many different ways. For instance, a metric of an ad suggester's effectiveness can be determined within different price ranges, such as effectiveness at suggesting ads for products between $1000 and $500 dollars as compared to ads for between $100 and $50 dollars. As another example, a metric of an ad suggester's effectiveness over time can be determined. In yet another example, a metric of an ad suggester's effectiveness within product categories can be determined, such as travel products or furniture. Further, a metric of an ad suggester's effectiveness can be determined for ad suggested for a particular product. These metrics are provided for the purposes of illustration only and are not meant to be limiting.

The metrics listed above can be determined on a per person basis or on a group basis. For instance, an ad suggester's effectiveness at suggesting ads for products or services between $500 and $100 dollars can be determined for ads sent to a particular ad recipient over time. In another example, an ad suggester's effectiveness at suggesting ads for products and between $500 and $100 can be determined for suggested ads sent to a group of recipients over time. In yet another example, an ad suggester's effectiveness can be determine for suggested ads sent to recipients in particular age ranges, such as over 50 years of age or between 20 and 55 years of age. The metrics listed above can also be determined for different time periods, such as the last week, last month, last 6 months, last year, etc.

One metric for measuring an ad suggester's effectiveness at selecting suggested ads for ad recipients can be referred to as a conversion rate. In one embodiment, a first type of conversion rate can correspond to a total number of ad activations resulting in purchases relative to a number of suggested ads sent. In another embodiment, a second type of conversion rate can correspond to a total number of ad activations including activations resulting in purchases and activations resulting in non-purchases (e.g., the ad is selected, the ad recipient goes to a site displaying products associated with the advertisement and views additional advertising. However, the ad recipient doesn't purchase a product or service associated with the suggested advertisement.)

The conversion rate may be determined using a number of techniques and with a variety of inputs. For example, one suitable conversion rate can use a ratio of a number of prior suggested ad activations (purchase only) for a suggester related to the number of prior of suggested ads sent by the ad suggested over some time period. The conversion rate may be determined using statistics between: a) an ad suggester and ad recipient, b) an ad suggester and all his ad recipients, c) an ad suggester and a group of contacts (e.g., ski trip friends, or college friends, etc.), d) an ad suggester and his family and/or e) combinations thereof. In a specific embodiment, the conversion rate is a global conversion rate for all the suggested ads sent by a suggester and is determined at the time of sending an advertisement to the recipient. It is noted these types of determinations can also be utilized for other metrics associated determining an effectiveness of an ad suggester and is not limited to the conversion rate.

Effectiveness metrics, such as conversion rates, can be used in the systems and method described herein for different applications. In one embodiment, effectiveness metrics can be employed in the compensation methods described above with respect to FIGS. 1 and 2. A variable rate of compensation tied to an effectiveness metric, such as a conversion rate, can be used within the interpersonal electronic advertising system to incentivize ad suggesters to provide electronic advertisement input and ads that are highly likely to result in purchases by recipients. It can also be used to disincentive spamming where a user tries to send a large number of suggested ads with a low probability of succeeding. Examples of utilizing a conversion rate in a compensation scheme are described with respect to the following paragraphs. When used in the method 101 described above with respect to FIG. 2, the conversion rate can be periodically updated so that a compensation percentage can reflect changes to the conversion rate.

In the jewelry store example, the conversion rate can be used to determine the son's compensation on his father's purchase. As described above, the conversion rate can be calculated in many different manners, such as on a per recipient basis or globally. For example, if the son in the jewelry example previously sent forty suggested ads and twenty were activated for purchases, then his conversion rate would be 50% suggested ads leading to purchases. If all forty of his ad suggestions were activated for purchases, the son's conversion rate would be 100%. As the son's conversion rate increases, the system can be configured to increase his compensation for a given activation. Likewise, as his conversion rate decreases, the system can be configured to lower his compensation. In this manner, son is incentivized to select suggested advertisements that are more likely to result in recipient activation. In one embodiment, if an ad suggester's rate becomes very low over some time period, i.e., the suggester is an ad spammer, the system can be configured to block the suggester from sending additional suggested ads.

In accordance with the example in the previous paragraph, the system can be configured to use a tiered conversion rate scheme to attribute compensation to an ad suggester. The tiered scheme can includes a number of tiers for the ad suggester's conversion rate, where each conversion rate tier conveys a dedicated compensation rate. Changes (up or down) to the ad suggester's conversion rate can cause their compensation to move between the conversion rate tiers and their predetermined conversion rate thresholds resulting in different compensation rates. Typically, a higher conversion rate tier results in a higher compensation percentage using the tiered system. For an increasing conversion rate, once the next conversion rate threshold number is reached, the system can be configured to increase the compensation percentage.

As described above, the conversion rate can vary over time. In one embodiment, a compensation percentage of the transaction can be based on the ad suggester's conversion rate at the time of sending the ad. In another embodiment, the compensation percentage of the transaction can be based on an average of the ad suggester's conversion rate at the time of sending the ad and the ad suggester's conversion rate at the time the ad is activated. In general, a conversion rate used to attribute compensation can be based upon conversion rates calculated at one or more times when compensation is being attributed for a particular suggested ad.

In a particular example, the conversion rate used to attribute compensation can be determined at the time an ad is suggested. In the jewelry example, if the son's conversion rate is 19%, and he suggests a jewelry store ad to father, and father activates the jewelry ad, the ad activation, depending on how the conversion is calculated, can elevate the son's conversion rate above 20%. When the conversion rate tiers are set at 10% increments, such as 10%, 20%, 30%, 40%, etc, the new higher conversion rate indicates the son may possibly earn additional compensation. In this embodiment, however, the system is configured to determine conversion rate at the time the ad is suggested for the purposes of attributed compensation. Thus, since the son suggested the ad while his conversion rate was 19%, the system is configured to receive compensation based on the compensation structure for a 19% conversion rate. On future activated ads, however, the son is eligible for the higher compensation at the compensation rate given to the high tier at 20%, while his conversion rate remains above 20%.

A tiered conversion rate compensation scheme may employ any number of tiers, where each successively higher tier conveys an increased compensation percentage, and each tier having a minimum conversion rate to qualify for the increased compensation percentage. When the conversion rate decreases to below the threshold level for a tier, the suggester's compensation percentage decreases to correspond with the lower conversion rate tier.

In one embodiment, the system can be configured to allow a user to select a tiered compensation system. For instance, a first compensation tier scheme can include larger compensations for higher ad conversion rates and lower compensations rates for lower ad conversion rates in particular tiers as compared to a second compensation tier scheme. The user may select the first compensation tier scheme because they believe they can maintain a high conversion rate. Thus, the user is willing to take the risk of using the first compensation tier system which may result in lower compensation if the conversion rate is not maintained but higher compensation if the conversion rate is maintained. A second user may be more conservative and choose the second compensation tier. The second user will earn more compensation at a lower conversion rates but less compensation if they obtain and maintain a high conversion rate.

In various embodiments, the compensation tiers can be used to attribute compensation to an ad suggester when an ad recipient makes a purchase that has been linked to the suggested ad. In addition, the compensation tiers can be used to attribute compensation to an ad suggester even if the ad recipient doesn't make a purchase. For instance, in some embodiments, compensation can be attributed to the ad suggesters for ad activations where the ad recipient has acknowledged receipt and/or awareness the ad in some manner.

As described above, an ad can be output via an interface that is configured to receive an input that indicates the ad has been acknowledged. For instance, via a GUI, an ad recipient can provide an input via an input device, such as a touch screen, a mouse or a track pad, that indicates a selection of the ad by the ad recipient. As another example, via an oral interface such as a digital assistant like Siri by Apple™ the ad recipient can request, verbally, information about the suggested ad. In response, the digital assistant can output a verbal description of the suggested advertisement. In yet another example, an eye tracking device can be used with a GUI to determine whether a user has looked at an advertisement. The tracked position of the user's eyes such as if they lingered at a location of the suggested ad can indicate awareness of the suggested ad. The input received from an interface from which a suggested ad is output can be used by the system to determine the ad recipient has acknowledged the ad in some manner. In response to the acknowledgement of the suggested ad, the system can attribute compensation to the ad suggester. Further details of interfaces that can be used to output ads are described below in the following section.

### Interfaces for Outputting Suggested Ads

As described above, various types of interfaces can be used to output suggested ads derived from an interpersonal electronic advertising system. Many types of interfaces can be primarily graphical in nature. However, other types interfaces, such as interfaces that are primarily sound based, like an interface based upon verbal commands and verbal responses using a digital assistant like Siri from Apple™, can also be utilized. Various input and output devices can be used to allow a user to interact with the interfaces. Examples of input devices that can be utilized include but are not limited to 1) touch sensitive devices, 2) sound detection devices that can include speech processing capabilities, 3) motion detection devices, such as devices incorporating cameras or accelerometers to detect motion to indicate inputs, and 4) mechanical devices such a keyboard or a mouse. Examples of output devices used with an interface can include but are not limited to video displays, sound generation devices that can include speech synthesis capabilities and haptic devices that generate detectable vibrations.

FIG. 3 illustrates a graphical user interface 201 for displaying a viewable page including one or more suggested ads, such as a page output via a web-browser. The interface 201 is configured to allow ad suggesters to contribute at least a portion of the content 45 that is displayed to the page, such as one or more of ads 16a, 16b and 16c. As shown, the page displayed by the interface includes locations for the placement of up to three advertisements where one or more of the placed ads can be suggested ads. Other pages formats are possible and the example is provided for the purposes of illustration only. The content 45 displayed on the page can vary depending on the purpose or theme of the page.

In one embodiment, the viewable page can be owned by a particular individual. Ownership may allow the individual to change aspects of what is displayed on the page at a particular time. In some instance, the interface 201 can be configured to generate a viewable page with one or more of a contacts module 175, an ad suggestion interface link 205 a dashboard link 207. The contacts module 175 can include a list of individuals associated with the owner of the page. As described below, the interface 201 can be configured to allow a user to suggest ads for individuals or groups of individuals. In some instances, contact information for the individuals or groups of individuals can be retained in the contacts module 175.

A selection of the ad suggestion interface link 205 can cause interface 201 to generate a page that allows a user access a database of ads that can be selected for particular ad recipients, such as individuals stored in the contact module 174. A selection of the dashboard link 207 can cause the interface 201 to generate a dashboard page that allows the user to assess a status related to the suggested ads they have previously suggested. For instance, via the dashboard page, a user can view information such as but not limited to a list of suggested ads they have previously sent, whether suggested ads have been activated and by who, ad suggestion effectiveness metrics, such as conversion rates related to the activation of suggested ads, past attributed compensation, etc.

In one embodiment, an interface for displaying suggested ads can be compatible with social media applications. When the interface 201 is used a social media environment, a portion of the content 45 that is displayed can be social media related. In other contexts, the content 45 displayed in the interface can be different. For example, if the interface 201 is used to access a web-site, the content 45 that is displayed can be consistent with a theme of the web-site.

In a specific embodiment, the interface 201 can output a social network profile page associated with a particular individual. In this case, the social network content 45 can include content personal to the individual. As an example, the content 45 can include news feeds, a status post, a news update, etc of interest to the individual.

In one embodiment, the interpersonal electronic advertising system can be configured to allow an individual to suggest ads for visitors to their social network profile page that are displayed via interface 201. In this example, ads 16a, 16b and 16c can be suggested ads selected by the owner of the page. When other individuals with a relationship to the individual visit the page, the interface 201 allow the visitors to activate the displayed suggested ads, such as 16a, 16b or 16c. After the suggested ads are activated, the owner of the social network profile page (ad suggester) can be compensated. The compensation rewards the page owner's efforts related to suggesting ads, gathering consumer information and social networking activities.

In one embodiment, when a social profile page is visited, the same suggested ads are displayed to everyone. In other embodiments, the system is configured to customize the suggested ads to each visitor. Thus, the ad suggester can suggest ads that are for an individual ad recipient or a group of ad recipients that visit their page. When an individual visits the page, the system can be configured to identify the visitor and then determine whether there are any suggested ads for the individual from the owner of the page. In one embodiment, when the owner of a page visits their own page, the system can be configured to display ads suggested for them from other individuals and/or ads they can select for others.

In the jewelry example described above, the son can create a social profile page via interface 201. Then, the son can select a suggested ad for their father, such as the jewelry advertisement. The suggested ad can be delivered to the father via some communication mechanism, such as text or e-mail. In addition, when the father 8 visits his son's page, the system can be configured to identify the father and determine whether there are suggested ads just for the father or the father falls within any groups that have been designated to receive a particular suggested advertisement. As an example, the son's 4 suggested advertisements for his father can include a jewelry store suggested ad 16a, a new family computer suggested ad 16b, and a sports car suggested ad 16c. Thus, father 8 visits his sons social profile page and the father can view a number of suggested ads from his son, such as 16a, 16b and 16c. As noted above, the system itself can also suggest ads for the father.

In some embodiments, the number of suggested ads for the father can be greater than the number of ad locations available on the page. For example, a son may have selected ten suggested ads for their father. However, only three locations are available for displaying the ads. In this situation, the system can be configured to rank each of the suggested ads relative to one another and display the top three ads.

When someone else visits the son's social profile page, a different set of ads can be displayed. For example, when his mother visits his page, a suggested ad for books the mother wants can be displayed in ad 16a, a suggested ad for a new family computer displayed can displayed in ad 16b, and a suggested ad for a spa getaway package in ad 16c. In the example, the suggested ad for the new family computer is displayed to both the mother and the father. The son may have selected that the ad for the computer to be displayed to family members. Further, the son may have identified the mother and the father as family members to the system. When the mother or father logs onto the system, the system can determine that the father or the mother are family members and then determine the new family computer suggested ad is to be displayed to each of them.

In general, the system can be configured to allow an ad suggester to define groups and then suggest ads for the group. For instance, the system can be configured to allow the ad suggester to create a group and then populate it from their contacts using the contacts module 205. The system can be configured to allow the user to delete or modify the members in a particular group. In particular embodiments, the system can be configured to allow an ad suggester to select the same suggested ad for multiple different groups.

As an example, an owner of the page can select the ad suggestion interface link 205 and the interface 201 can display an ad suggestion interface page. Via the interface, an ad can be selected for a discount ski pass for a particular resort 16. Next, the interface 201 can be used to create and populate a group, such as “ski friends.” Then, the ski pass suggested ad can be selected for the group “ski friends.” When someone in the ski friends groups views the social network profile page via interface 201, the system can identify the person as being a member of the ski friends group and the suggested ad for the particular ski resort can displayed. The ad suggester can be compensated at least each time one of the friends in the group purchases a lift ticket via the advertisement.

The interface 201 is not limited to displaying only three ads. In general, the interface can be configured to output one or more ads. The number of ads that are displayed to a page can vary over time. In addition, the system can be configured to vary the size and the placement location of the one or more ads displayed to a page at a given time. Further, the system can be configured to vary the content and format of a displayed advertisement. For instance, at one time, the content and format of a first suggested ad for a product can include selected content formatted to be output as a video with sound. In another embodiment, a second suggested ad for the same product can include selected to be output as a still image without sound.

Multiple suggested ads can be provided for the same product and the system can be configured to select from among the multiple ads to output via the interface. For example, at a first time, a first suggested ad 16a can be output for a particular product. Then, at a later time, the system can refresh the social media profile page and a second suggested ad for the same product can be displayed.

A particular number of ad spaces in which suggested ads are output can be specified for a particular page format. For example, in FIG. 3, the page is configured with 3 ad spaces. In some embodiments, the number of suggested ads for available for a particular page format can be less than or greater the number of ad spaces that are available for suggested ads. When the number of suggested ads is less than the number of ad spaces, in one embodiment, the system can be configured to suggest ads to fill the unallocated ad spaces. In another embodiment, the system can be configured to only display the one or more available suggested ads. For example, if only one suggested ad is available, then for the page in FIG. 3, only one suggested ad might be displayed in location 16a and the locations for 16b or 16c can be left blank or the only suggested ad can be displayed in all three locations. In yet another embodiment, the system can be configured to reformat the page to reduce or eliminate the unfilled ad spaces. For instance, if one suggested ad is available, then the interface can be configured to expand the size and/or rearrange the remaining components, i.e., ad 16a, content 45, contacts module 175, ad suggestion interface link 205 and dashboard link 207 such that at least a portion of the available space associated with 16b and 16c is filled by the other page components.

When the system determines that more suggested ads are available then ad spaces are available on page, in one embodiment, the system can be configured to adjust the format of the page to increase the available ad spaces. For instance, if four suggested ads are available for the page shown in FIG. 3, the system can be configured to adjust the format of interface 201 to include 4 ad spaces instead of 3. The re-formatted can involve rearranging and resizing various components on the page.

In another embodiment, when more suggested ads are available for a page then ad spaces the system can be configured to rank the ads. Based upon the rankings, the system can distribute the ads to the ad spaces available on a page provided by interface 201. For example, if the system determines ten suggested ads are available for the page shown in FIG. 3, then the system can be configured to rank in order each of the ten ads and then display the three highest ads to ad spaces 16a, 16b and 16c.

### Dashboard Interface

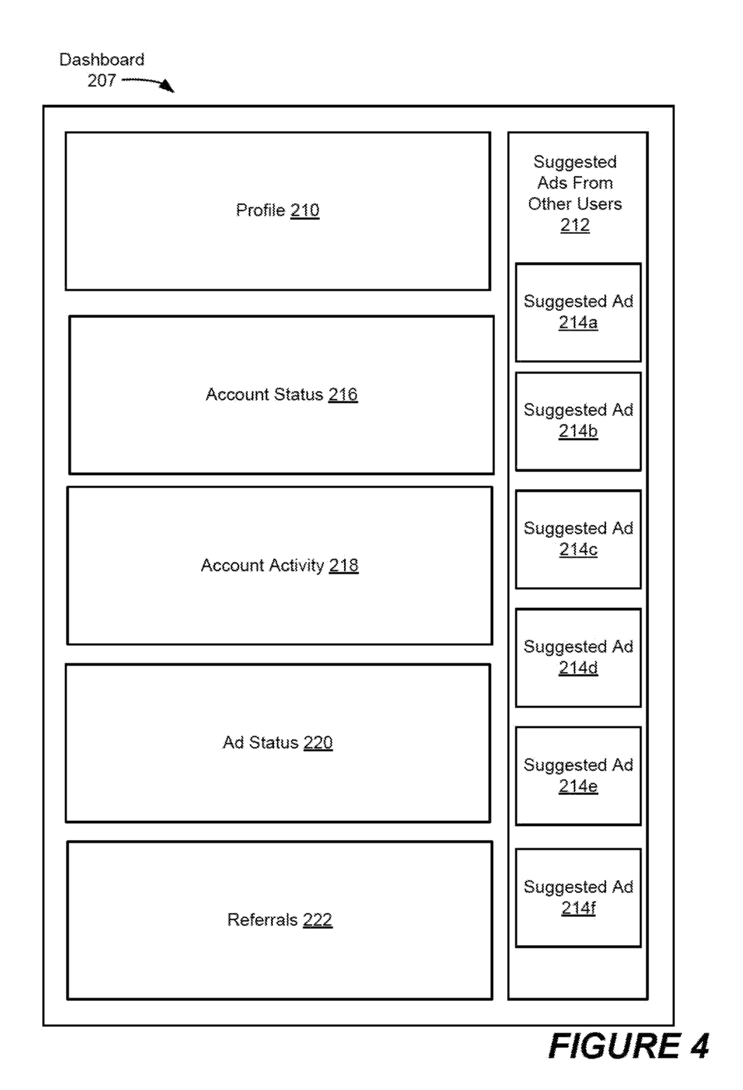

In this section, an interface that allows a user to monitor some of their activities within the interpersonal electronic advertising system is described. The interface can be referred to as a “dashboard.” FIG. 4 illustrates components of a dashboard configured to allow a user to monitor their activities in accordance with the described embodiments.

The dashboard 207 can include one or more of a i) profile section 210, ii) a list of ads section 212, iii) an account status section 216, iv) an account activity section 218, v) an ad status section 220, vi) a referrals section 222 and combinations thereof. The dashboard 207 can be user configurable to allow user to select a combination of these components to display. Further, the user may be able to select from among different format styles to utilize in the interface, such as different formats for graphically presenting information.

The profile section 210 can include information about the user associated with the account. For instance, the profile section can include one or more of an image of the user, commissions paid, commissions pending, a conversion rate, a commission rank and a message ticker. As described above, a user can earn higher commissions under certain conditions, such as maintaining a high conversion rate. The rate that a user is compensated for commission can be indicated by the commission rank. The message ticker can show one or more recent messages associated with the account.

The list of ads section 212 can include a list of suggested ads that have been sent by the user or sent to the user. The list can be ordered according to some ranking criteria. For instance, suggested ads associated with higher commissions can be listed first. The account status section 216 can provide more refined details of account status. For instance, it might show a number of suggested ads sent, a number of purchases made and account activity broken down by month, such as revenue per month, suggested ads sent per month or purchases made per month.

The account activity section 218 can show refined details of account activity. For instance, it can show details of the latest suggested ads that have been sent, such as to whom it was sent, whether the recipient clicked on or otherwise activated the ad, what product or service is described in the ad and a time that the suggested ad was sent. The ad status section 220 can provide details of the status of individual ads. For instance, the section 220 can include information regarding the ad recipient, details of the suggested ad, whether the suggested ad has been sent, whether a purchase associated ad has been made, whether compensation associated with the suggested is being processed, whether compensation associated with the suggested ad has been paid, an amount of compensation to be paid and a destination for the payment, such as an individual account or a third party account.

The referrals section 222 can include information related to a referral program where a user can be compensated for recruiting non-users to join the system. The referrals section 222 can include information related to how many people a user has referred to the system, activities of the referrals and details of a rewards program associated with referrals. In addition, the referrals section can include a selectable button that allows a user to invite someone to join the system. When an invitee joins the system, the invitee becomes a referral of the user. Details of the referrals section 222 and associated referrals rewards program are described follows with respect to FIGS. 5A, 5B, 5C and 6.

### Referral Interface and Reward Program Structure

In this section, a referrals rewards program and associated interfaces are described. The rewards for a user can be based upon the activities of one or more other users within the interpersonal electronic advertising system that have been referred to the system by the user. FIGS. 5A, 5B and 5C illustrate components of a graphical user interface configured to allow a user to monitor their progress towards rewards resulting from the activities within the interpersonal electronic advertising system of other users that have been referred to the system by the user.

In FIG. 5A, components of a referral interface 222 are shown. The referrals component 228 can include information about the additional users that a user has referred to the system. The information can include but is not limited to a number of users that have been referred and details about the referrals, such as their names, recent activities and if they joined the system. The referral performance section 230 can show aggregate performance data of the referrals on the system. In one embodiment, the aggregated performance data can be presented such that it is associated with reward objectives associated with a referral reward program.

The invite a friend component 224 can be a selectable link that initiates a process that allows a first user to invite a second user to join the system. When the second user that is invited joins the system, then the second user can become a referral of the first user. After the second user joins the system, the second user can begin selecting suggested ads to send to ad recipients. In addition, the second user can invite additional users to join the system that can become referrals of the second user. The second user can then earn rewards in the referral reward based upon the activities of their referrals within the system.

The system can be configured to notify the first user if an individual that they have invited is already a current member of the system. Further, the system can be configured to notify the first user when an individual that they have invited joins the system. In one embodiment, a secondary interface that enables the first user to invite another person to join the system can be generated in response to a selection of the invite a friend link 224. An example of a second interface that allows the first user to invite another person to join the system is described below with respect to FIG. 6.

The reward structure section 226 can include details about the rewards program such as the requirements needed to start earning rewards and objectives to earn rewards. As an example of a requirement to start earning rewards, the rewards program can be structured such that a user may have to successfully refer a threshold amount of users to the system, such as 10 users, before the user can begin to earn rewards in the rewards program. As an example of a reward objective, the system can be configured to provide a reward to the user when their referrals have selected a certain number of suggested ads that have resulted in purchases.

In one embodiment, the reward for a number of purchases can be a fixed amount, such as $10 dollars after five purchases completed by their referrals. In another embodiment, the reward can be based upon a percentage of the value of goods or services that have resulted from the suggested ad purchases, such as 3% of the total value of the purchases resulting from the purchases. In yet another embodiment, an award can be a portion of the total ad commissions resulting from one or more suggested ad purchases, such as 10% of the total ad commissions earned by their referrals.

In the referrals reward program, a reward can be provided to a user when a total value purchases resulting from suggested ads sent by their referrals reaches a threshold value. For example, when the total value of the purchases reaches a first threshold value, a first reward can be provided and when the total value of the purchases reaches a second value threshold value a second reward can be provided. In one embodiment, the rewards can be adjusted depending on how fast the threshold values are reached. For example, if a first threshold value for total purchases is reached within a week, then a first reward can be provided and if the first threshold value for total purchases is reached within 3 months a second reward different than the first reward can be provided. In one instance, the second award associated with the longer time period can be less than the first reward.

In one embodiment, the rewards in the referral program can be determined on an individual by individual basis. For instance, based upon a number of purchases by a first referral and/or a total value purchases by the first referral, rewards can be provided when certain threshold values are reached. The referral program can be structured such that a reward is provided each time a referred individual reaches a threshold value of the purchases or total value of purchases. For example, a first reward can be provided when the total purchases of a first individual reaches a first value and a second reward can be provided when the total purchases of a second individual reaches the first value. Thus, the user in the referrals awards program can continue to earn awards as they refer additional users to the system over time.

In another embodiment, the rewards in the referral program can be determined on a group basis. For instance, the system can be configured to determine rewards for a first user based upon the total value of purchases resulting from suggested ads from their referrals. All of the referrals made by the first user don't have to be considered in this determination. For example, if the first user has referred 20 users, the value of purchases from each user can be determined and only the purchases from the top ten referrals according to purchase amount can be used to determine the total value of purchases. As described above, in one embodiment, a user may have to achieve a threshold amount of referrals, such as ten referrals, before the user can begin earning rewards.

In yet another embodiment, the rewards in the referrals reward program can be determined for multiple different groups. For example, if a first user refers 20 different users, a first set of rewards can be earned based upon the activities of the first 10 referrals and a second set of rewards can be earned based upon the activities of the second 10 referrals. In this example, each time a threshold amount of referrals is reached, a new group can be formed and rewards can then be separately determined based upon only the activities of the referrals in the new group and not the activities of referrals in other groups.

Various limitations can be associated with the rewards program. One limitation is that a maximum reward amount may be specified. When the maximum reward amount is reached no additional rewards will be earned based upon the referral activities. Another limitation can be that activities of the referrals may have to occur within a particular time period to count towards a reward. For example, the rewards can be based upon activities that have occurred within the last three months and activities outside of three months may not contribute to the rewards. In general, any time period can be selected, such as 1 year, 6 months, 3 months, 1 month, etc., where only activities within the selected time period are considered for awards.

FIG. 5B is one example of a referral interface 222. In the reward structure section, three goals, 238a, 238b and 238c, are shown. The goals can indicate objectives for obtaining rewards, such as a total value of suggested ad purchases by the first user's referrals of $100, $1,000 and $10,000 dollars respectively. A reward, such as 240a, 240b and 240c, can be associated with each objective. In one embodiment, the rewards can be a monetary amount. For example, reward 240a can be ten dollars, reward 240b can be one hundred dollars and reward 240c can be one thousand dollars.

In another embodiment, the rewards can affect the first user's ability to earn money within the system. For instance, reward 240a can be a 10% bonus added to their commissions for the next 6 months, reward 240b can be a 20% bonus added to their commissions for the next 6 months and reward 240c can be a 30% bonus added to their commissions for the next 6 months. In yet another embodiment, the rewards can be points. The system can be configured to allow the user to redeem the points for various rewards, such as cash, merchandise or services. For instance, reward 240a can be 100 points, reward 240b can be 1000 points and reward 240c can be 10,000 points.

In one embodiment, the system can be configured to allow a user to select particular rewards that are to be used. For example, the user can select that reward 240a is to be cash and select that reward 240b is to be a bonus based upon the total commission resulting from purchases of their suggested ads. In another embodiment, the system may allow a user to select the goals. For instance, the user can specify that they wish to earn a reward after twenty five, fifty or one hundred purchases are made from suggested ads by their referrals. As another example, the user can specify that they wish to earn a reward after $500, $5000 and $50,000 in a total value of purchases resulting from the suggested ads of their referrals. Depending on the objectives that are selected by the user, the system can be configured to display a corresponding reward associated with the selected reward. For instance, a first reward can be displayed when an objective of $500 dollars is selected and a second reward can be displayed when an objective of $1000 dollars is selected.

The destination (“Dest”) column can indicate entities that are to receive a reward. The system can be configured to allow the user to specify different entities to receive an award. For instance, destination 242a can be a charity, destination 242b can be a family member and destination 242c can be the user. If one of the destinations is not specified, the entry space can be configured to indicate this information. For example, if a destination has not been specified for 242a, then the word “add” can be included in the space. If the word “add” is selected, an interface can be generated that allows the first user to enter a specific destination.

If a destination is specified, the space in the destination column can indicate information about the destination. For example, the word “Red Cross” can appear in space 242b to indicate a reward that is earned is to be sent to the Red Cross. The system can be configured to allow a user to change the destination up until a time that a process to send the reward to the specified destination has been started. For example, the user may initially specify sending the reward to the Red Cross but subsequently change their mind and specify that the reward be sent to a local food bank.

As described above, information about the referrals can be specified. In FIG. 5B in 228, the total number of referrals 244 for the user is displayed. As an example, the figure indicates that user has made twenty five referrals. The number of referrals is displayed graphically as a circular gauge. A portion 246 of the gauge is highlighted. This portion indicates a fraction of a total number of referrals associated with the gauge. For example, portion 246 can represent twenty five out of one hundred fifty users associated with the gauge. The total number of users can be graphically presented in many different formats and the use of the gauge is presented for the purposes of illustration only. Further, a graphically representation is not required and in some embodiments that information can be output in only a text format.

In FIG. 5C in 228, a list of persons is presented. The list of persons might include the names of each of the user's referrals. A value is associated with each referral. The value can represent some aspect of a referral's activities on the system. For example, the value might be the total number of purchases that the suggested ads of the referral have generated or a total value of the purchases. Other types of activity data can be represented and the total number of purchases or value of the purchases is presented for the purposes of illustration only.

In the referral performance section 230 in FIG. 5B, a graphical representation of a user's progress toward rewards is shown. A circular gauge is shown. In the center 236 of the gauge, a total value of purchases of the user's referrals, nine hundred dollars, is shown. If the rewards are based upon a different quantity, such as a total number of purchases, then this parameter can be shown in the gauge. A first portion 232 of the gauge represents a first objective. A percentage is included in the first portion 232. For portion 232, one hundred percent is used to indicate that the objective associated with the first objective has been met. This information can also be presented in the reward structure section 226. For example, a space can be provided next to each goal where an indicator can be placed in the space to indicate whether the objective has been reached or not.

In FIG. 5B, the second portion 234 is used to indicate progress toward as second objective. The second portion 234 includes the text “ninety percent.” The ninety percent indicates that the first user is ninety percent of the way to obtaining the second objective. As described above, the first objective and the second objective don't have to be the same quantity. For instance, the first objective can be twenty purchases from the referrals and the second objective can be a total value of the purchases of $1000 dollars. Thus, the percentage in each of portions, 232 and 234, can represent a progress to each of these different objectives respectively.

In FIG. 5C, objective data is represented in a different format. Three objectives, which are dollar amounts of ten, one hundred and one thousand dollars are shown at the top of the section 230. A bar 250 is associated with each objective. The size of the bar increases until the objective is reached. For example, a first bar associated with a completion of a first objective is shown under the ten dollars and a second bar associated with a second objective is shown under the hundred dollars. The second bar is smaller than the first bar because the second objective is only sixty percent completed while the first bar represents an objective that has been reached. Many other formats for showing referral performance data and progress towards objectives in a rewards program can be utilized and the examples shown in FIGS. 5B and 5C are presented for the purposes of illustration only.

As described above, the invite a friend section 224 can include a selectable link or some other selection mechanism associated with an electronic interface. When the link is selected, an interface can be triggered that allows a user to invite another individual to join the system. An example of such an interface is described with respect to the following figure.

FIG. 6 illustrates a graphical user interface 260 that allows a user to invite a non-user to join the interpersonal advertising system. The interface 260 is configured to allow a user to specify a name 262 of the invitee. A first and last name can be entered in text boxes 268 and 270. The interface 260 can be configured to allow a user to specify a means of contact. For instance, in one embodiment, an e-mail address 264 can be entered into the text box 272. In other embodiments, other contact information can be specified. For instance, a phone number to which a text message including an invitation is to be sent can be entered instead of or in addition to an e-mail address.

In one embodiment, although not shown, the system can be configured to allow a user to enter a personal message that can be entered with the invite. The personal message can include information that allows the invitee to determine that the inviter is someone that invitee knows and trusts. After entering the information, such as the invitee name and contact information, a mechanism can be provided that causes the system to generate and send the invitation. For instance, the mechanism can be a selectable link 266 in interface 260.

Besides a direct invitation from a current user, the system can be configured to encourage registration through other mechanisms. For instance, a selectable link can be included in a suggested ad sent from the user to an ad recipient. When the link is selected, a registration interface can be generated that allows the ad recipient to register with the system if they are not yet a member. In one embodiment, an individual that registers in this manner can be considered as a referral of the user that sent the suggested ad to the individual. In another embodiment, an individual that registers in this manner is not considered as a referral of the ad suggester that sent the suggested ad.

In one embodiment, the interface 260 can include a contacts section 274. The contacts section 274 can include a list of individuals and information about the individuals that are associated with the user. As examples, the contacts section 274 can include images 276, such as a photo or avatar, associated with each contact and details of about the contact, such as their name, relationship and contact information. In one embodiment, the individuals in the contacts section 274 can be ad recipients to which the user has previously sent suggested ads. In another embodiment, when a user invites someone to join the system and become one of their referrals, the information about the invitee can be added to the contacts section 274.

The interface 260 can include an invitees section 280. The invitees section 280 can include information about all of the individuals that the user has invited to join the system. Like the contacts section 276, the invitees section 280 can include information, such as but not limited to an image 282 of the invitee and details 284 about the invitees, such as their name, contact information and relationship to user. In addition, the invitees section 280 can include a status 286 related to each of the invitees. The status 286 can indicate whether the invitee has joined the system and become a referral of the user. In FIG. 6, person-1 and person-4 in the invitees section 280 are shown as having joined the system and are now referrals for the user.

Typically, a referral is associated with a particular account that is owned by an individual. The system can be configured to allow an account to become a referral to one other account only one time. It is possible that an individual can open multiple accounts. Via the multiple accounts, a single individual might be able to act as a referral for multiple different individuals or even become a referral of themselves. In one embodiment, the system can be configured to determine whether an individual is associated with multiple accounts. For instance, the accounts might list common bank account information for payment. This information can be used by the system to determine that the accounts are controlled by the same individual.

In one embodiment, when an individual controls multiple accounts, the system can be configured to allow the individual to be a referral only one time. Thus, if the individual joins the system and opens a first account as a referral to another system user, the system can be configured not to allow the individual to be a referral to themselves or another user if they open a second account. The system may block the second account from being used for referral purposes when it determines the first and second account are controlled by the same individual.

In addition, the system can be configured to count activities from multiple accounts controlled by the same person for earning rewards in a referral program. For instance, if an individual opens a first account and becomes a referral of user and then opens a second account where a referral is not specified, the system can be configured to determine the first and second account are owned by the same individual and count activities from the first and the second account for the purposes of determining referral rewards for the system user that initially invited the individual to join the system.

### Methods Involving Referrals

Next details of methods involving compensation of users based upon the activities of other users in the system, such as a referrals rewards program, are described with respect to FIGS. 7 and 8. FIG. 7 is a flow chart of a method including user registration and compensation in an interpersonal electronic advertising system 300. In 302, a first user can register with the system. Registration can occur through a registration interface generated by the system. During registration, the system can receive information such as a user name, contact information and payment information. After registration, the first user may begin to select and send suggested ads to ad recipients.

In 304, the system can receive a request to invite a second user. In one embodiment, the request can be generated via a system generated interface, such as the interface described above with respect to FIG. 6 after the first user has selected the “invite a friend” button in FIG. 5. Based upon the information entered by the first user describing the invitee, the system can send an invite to the second user to join the system. The invite can be in the form of an electronic message.

The electronic message can include an identifier that allows the system to determine that the second user has been referred by the first user. For example, the electronic message can include a registration number that the second user can enter when they register with the system. In another example, the electronic message can include a link, such as a URL, that when selected leads to a registration interface. The URL can include a unique portion that allows the system to determine that the registration is associated with the first user.

In 308, the system can register the second user such that the second user is identified as a referral of the first user. Thus, information associated with the second user can be stored to the first user's account and vice versa. Further, the system may notify the first user that the second user has accepted the invite and become a referral of the first user. The system may notify the second user that the first user can earn rewards based upon their activities and/or that they can also earn rewards if they refer other individuals to the system.

In 310, the system can monitor activities of the second user. The activities can include sending suggested ads to ad recipients and whether the suggested ads have resulted in purchases. Performance data associated with the purchases, such as purchase amount or commission amount, can be determined. The performance data can be used to update a referral interface that is viewed by the first user. Updates can include the latest information on the first user's progress towards rewards in a referral rewards program.

In 312, the second user can be attributed compensation based upon their activities in the system. For instance, the second user can receive commissions when suggested ads result in purchases. In 314, the first user can also receive compensation based upon the activities of the second user. For instance, the first user can receive compensation when the total value of purchases derived from suggested ads of the second user exceed a threshold amount. In addition, the first user can send their own suggested ads to ad recipients and receive compensation based upon whether their suggested ads result in purchases by the ad recipients.

FIG. 8 is a flow chart of a method 400 of user registration including referral rewards. In 402, a plurality of different new users can be registered with the system based upon referrals from the first user. The system can be configured to associate the plurality of different new users as referrals of the first user. In 404, the system can monitor the activities of the plurality of new users. For instance, the system can detect for each user of the new users whether suggested ads sent by the users have resulted in purchases and compile data associated with the purchases, such as purchase amounts and commissions.

In 406, based upon the activities of the plurality of new users, the system can determine the first user's progress towards receiving a reward. In 408, the system can output information related to the first user's progress towards one or more different rewards in a referrals reward program and information about the different awards, such as a reward amount. In 410, the system can determine a reward level is reached and distribute the reward associated with the reward level to the first user. The distribution can involve sending an electronic payment to a personal account specified by the user or a third-party account specified by the user. The system can also notify the first user that they have received the reward and provide information about the reward, such as an award amount and when it was paid.

### Network and Devices

FIG. 9 illustrates a diagram of a sample network 241 in which systems and methods consistent with the principles of the embodiments described herein may be implemented. Network 241 includes one or more clients 243 connected to one or more servers 245-247 via a network 249. Two clients 243 and two servers 245-247 have been illustrated as connected to network 249 for simplicity. In practice, there may be more or fewer clients and servers. Also, in some instances, a client performs a function of a server and a server performs a function of a client.

Clients 243 can be electronic devices, such as a personal computer, a wireless telephone, a personal digital assistant (PDA), a laptop computer, a mobile device, an mp3 player, a tablet, a television, a thin client, or any other type of computation of communication device, a thread or process running on one of these devices, or an object executable by one of these devices. One or more users (e.g., an ad suggester 4 or recipient 8) are associated with each client 243. Servers 245 and 247 include server entities that access, fetch, aggregate, process, search or maintain data in a manner consistent with the principals of the disclosure. Clients 243 and servers 245 and 247 connect to network 249 via at least one network interface that may include one or more wired, wireless, cellular or optical connections, or any other type of connection. The network interface relays communications to network 249. In one embodiment, clients 243 or servers 245 and 247 include a network interface dedicated to receiving input and a second network interface dedicated to send data to the network 249. In a specific embodiment, clients 243 or servers 245 and 247 includes a single network interface that both receives and sends data via the network 249.

In one embodiment, server 245 includes an advertisement system 251 useable by users at clients 243. Server 245 may implement an advertisement platform with advertisements from one or more vendors and sources, index the ads and store information associated with the ad data in a storage device. In some embodiments, server 245 hosts advertisements that are provided to users at clients 243. In one embodiment, ad system 251 provides an advertisement suggestion interface to clients 243. Via the interface, the ad system can provides a listing of ads that an add suggester can select. The system can be configured to receive electronic advertisement input. In some embodiments, the electronic advertisement input can be used in a search feature associated with the interface. The search feature can be used to locate particular ads that a user may wish to suggest. After ads are selected, ad system 251 can be configured to execute an advertisement provision function that allows a suggested ad to be sent an ad recipient. The ad recipient can access the suggested ads via one of the client devices.

Server 247 stores or maintains data that may be crawled by server 245. In one embodiment, the server 245 can store ad related data. Such data may include information described above for data storage 30.

Network 249 includes one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The telephone network may further include 3G, 4G, or Mobile WiMAX, Long Term Evolution (LTE). The PLMN(s) may further include a packet-switched sub-network, such as, for example, General Packet Radio Service (GPRS), Cellular Digital Packet Data (CDPD), or Mobile IP sub-network.

While servers 245 and 247 are shown as separate entities, it may be possible for one of servers 245 or 247 to perform one or more of the functions of the other one of servers 245 or 247. For example, servers 245 and 247 may be implemented as a single server. It may also be possible for a single one of servers 245 or 247 to be implemented as two or more separate (and possibly distributed) devices. In addition, in some embodiments, one or more functions attributed to the servers 245 and 247 in the description provided herein can also be implemented on one of the clients or vice versa.

FIG. 10 illustrates a sample computing system 261, which may correspond to one or more of clients 243 and/or servers 245-247. Computer system 261 comprises a processor, or CPU, 263, input device 265, output device 267, communication interface 269, system bus 271, one or more main memory 273, ROM 275, BIOS 277, and storage device 279. System bus 271 permits digital communication between system processor 263 and ROM 275, as well as permits communication between other components within system 261 and processor 263 and/or ROM 275.

Processor 263 is a commercially available microprocessor such as one of the Intel or AMD family of chips, or another suitable commercially available processor. Processor 263 digitally communicates with ROM 275 via system bus 271, which may comprise a data bus, control bus, and address bus for communication between processor 263 and memory 273. CPU 263 is also coupled to the communication interface 269 by system bus 271 to permit data transfers to and from computing system 261.

System memory can include read only memory (ROM), such as 275. Other memories may be included or substituted for ROM 275, such as random access memory (RAM) 273. Computer system 261 may also include a storage device 279, such as a hard disk drive or an optical disk drive, for example. The drives and their associated computer-readable media provide non-volatile storage for system 261. A number of program modules are stored in the drives, ROM 275, and/or RAM, including an operating system, one or more application programs, other program modules, and program data. Although data storage above refers to a hard disk and optical disk, those skilled in the art will appreciate that other types of storage are suitable for use with a computer system, such as magnetic cassettes, flash memory cards, USB memory sticks, and the like. In addition, not all computer systems, such as PDAs and other portable devices include multiple external memory options.

Communication interface 269 provides an interface between CPU 263 and such peripheral devices as a display device, input device 265, output 267, network interface, and/or any other I/O device. For example, a mouse used as input device 265 digitally communicates with processor 263 through a serial port 269 that is coupled to system bus 271. Other interfaces, such as a game port, a universal serial bus (USB) or fire wire, may also provide digital communication between a peripheral device and processor 263. Output 267 may comprise one or more speakers employed by a headphone or speaker system. Input device 265 allows a user to enter commands and information into the computer system 261, and may comprise a keyboard, a mouse, a position-sensing pad on a laptop computer, a stylus working in cooperation with a position-sensing display on a PDA, a touch screen system, a microphone, a touch sensitive device or the like.

In addition to personal computers such as desktop computers and laptop computers, a variety of other computer systems and computer devices employing a digital processor, memory and a display device may implement techniques described herein. Handheld computers and other small portable digital devices such as cell phones and digital cameras are increasingly integrating video display and computer functionality. One current trend is hybrid entertainment devices that integrate the functionality of computer systems, phones, and gaming systems. Any of these devices may implement the advertising methods and compensation systems described herein. The scope of digital computer systems is expanding hurriedly and creating new devices suitable for use herein.

Embodiments of the present invention further relate to computer readable media that include executable program instructions for performing interpersonal advertisement techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

Interpersonal advertising and compensation system software and interfaces such as those described herein may be implemented using a number of computer languages and in a number of programming environments. One suitable language is Java, available from Sun Microsystems of Sunnyvale, Calif. Another suitable programming environment is the Microsoft Windows™ programming environment, which provides a series of operating systems suitable for implementing the present invention both on laptop computers and handheld computers. C or C++ are also suitable for use herein.

Although the foregoing invention has been described in some detail for purposes of clarity of understanding, those skilled in the art will recognize that various modifications may be made within the scope of the appended claims. In addition, although advertising has not been detailed for every type of electronic device, the present invention is suitable with any technology that provides electronic advertisements. The invention is, therefore, not limited to the specific features and embodiments described herein and claimed in any of its forms or modifications within the scope of the appended claims.

1.-11. (canceled)

12. A method in an interpersonal advertising system, the method comprising:
generating in a processor an account for a first user;
generating in the processor accounts for a plurality of users referred to the system by the first user;
receiving in the processor selections of a plurality of suggested ads from the plurality of users;
based upon purchases resulting from the plurality of suggested ads, determining in the processor a reward in a referral reward program for the first user; and
attributing in the processor the reward to the first user.

13. The method of claim 12, wherein the reward is attributed to the first user when the reward satisfies one or more objectives associated with the reward.

14. The method of claim 13, wherein an objective associated with the reward is that a number of users referred to the system by the first user is to exceed a threshold value.

15. The method of claim 13, wherein an objective associated with the reward is that a total value of purchases resulting from the plurality of suggested ads is to exceed a threshold value.

16. The method of claim 15, wherein the reward attributed to the first user is a percentage of the threshold value.

17. The method of claim 13, wherein an objective associated with the reward is that a total number of purchases resulting from the plurality of suggested ads is to exceed a threshold value.

18. The method of claim 13, wherein the reward is cash.

19. The method of claim 12, wherein the reward is an increased compensation rate on purchases resulting from suggested ads sent by the first user.

20. The method of claim 12, further comprising:
receiving a request initiated by the first user to invite each of the plurality of users to join the system.

21. The method of claim 12, further comprising:
receiving a request initiated by the first user to invite a second user to join the system;
determining the second user is already within the system; and
sending a message to the first user indicating the second user is already within the system and is not eligible to be a referral of the first user.

22. The method of claim 12, further comprising:
based upon purchases resulting from the plurality of suggested ads, determining progress towards a plurality of reward in the referrals reward program for the first user.

23. The method of claim 12, further comprising:
receiving a request initiated by the first user to invite a second user to join the system;
outputting to an electronic interface associated with the first user information indicating whether the second user has joined or has not joined the system.

24. The method of claim 12, further comprising:
outputting to an electronic interface associated with the first user information indicating the progress towards the reward.

25. The method of claim 12, further comprising:
outputting to an electronic interface associated with the first user information related to the one or more objectives.

26. The method of claim 12, further comprising:
outputting to an electronic interface associated with the first user information related to one or more rewards that can be earned in the referrals reward program.

27. (canceled)

28. A computer readable medium including instructions for a processor in an interpersonal electronic advertising system, the computer-readable medium comprising:
computer code for generating in the processor a first account for a first user;
computer code for receiving in the processor selections of first suggested ads for first ad recipients from the first user;
computer code for generating in the processor a second account for a second user;
computer code for receiving in the processor selections of second suggested ads for second ad recipients from the second user; and
computer code for attributing in the processor compensation to the first account and the second account based upon purchases resulting from the second suggested ads.

29. An interpersonal advertising system comprising:
a processor, a memory and a network interface wherein the processor is configured to:
generate an account for a first user;
after the account is created, generate accounts for a plurality of users referred to the system by the first user;
receive selections of a plurality of suggested ads from the plurality of users via the network interface;
based upon purchases resulting from the plurality of suggested ads, determine progress towards a reward in a referrals reward program for the first user; and
crediting the reward to the first user when the progress satisfies one or more objectives associated with the reward.

30. The interpersonal advertising system of claim 29, wherein an objective associated with the reward is that a number of users referred to the system by the first user is to exceed a threshold value.

31. The interpersonal advertising system of claim 29, wherein an objective associated with the reward is that a total value of purchases resulting from the plurality of suggested ads is to exceed a threshold value.

32. The interpersonal advertising system of claim 31, wherein the reward credited to the first user is a percentage of the threshold value.

33. The interpersonal advertising system of claim 29, wherein an objective associated with the reward is that a total number of purchases resulting from the plurality of suggested ads is to exceed a threshold value.

34. The interpersonal advertising system of claim 29, wherein the reward is cash.

35. The interpersonal advertising system of claim 29, wherein the reward is points redeemable for merchandise or services.

36. The interpersonal advertising system of claim 29, wherein the reward is an increased compensation rate on purchases resulting from suggested ads sent by the first user.

37. The interpersonal advertising system of claim 29, wherein the processor is further configured to receive a request initiated by the first user to invite each of the plurality of users to join the system.

38. The interpersonal advertising system of claim 29, wherein the processor is further configured to:
receive a request initiated by the first user to invite a second user to join the system;
determine the second user is already within the system; and
send a message to the first user indicating the second user is already within the system and is not eligible to be a referral of the first user.

39. The interpersonal advertising system of claim 29, wherein the processor is further configured to:
based upon purchases resulting from the plurality of suggested ads, determine progress towards a plurality of rewards in the referrals reward program for the first user.

40. The interpersonal advertising system of claim 29, further comprising:
receive a request initiated by the first user to invite a second user to join the system;
output to an electronic interface associated with the first user information indicating whether the second user has joined or has not joined the system.

41. The interpersonal advertising system of claim 29, wherein the processor is further configured to:
output via the network interface an electronic interface associated with the first user information indicating the progress towards the reward.

42. The interpersonal advertising system of claim 29, wherein the processor is further configured to:
output to an electronic interface associated with the first user information related to the one or more objectives via the network interface.

43. The interpersonal advertising system of claim 29, wherein the processor is further configured to:
output to an electronic interface associated with the first user information related to one or more rewards that can be earned in the referrals reward program via the electronic interface.
